(19) United States
(12) Patent Application Publication
(10) Pub. No.: US 2023/0335043 A1
(43) Pub. Date: Oct. 19, 2023

(54) ELECTRONIC DEVICE AND METHOD OF CONTROLLING ELECTRONIC DEVICE

(71) Applicant: Sony Semiconductor Solutions Corporation, Kanagawa (JP)

(72) Inventors: Masashi Nakata, Kanagawa (JP); Takahiro Akahane, Tokyo (JP); Junichi Kanai, Kanagawa (JP)

(21) Appl. No.: 18/044,517

(22) PCT Filed: Sep. 8, 2021
(86) PCT No.: PCT/JP2021/032981

§ 371 Date: Mar. 8, 2023

(30) Foreign Application Priority Data
Sep. 28, 2020 (JP) 2020-162530

(51) Int. Cl. G09G 3/32; G06T 5/50; G06V 40/16; G06F 3/14

(52) U.S. Cl. CPC G09G 3/32; G06T 5/50; G06V 40/171; G06F 3/14; G06V 2201/07; G06T 2207/20044; G06T 2207/20221; G06T 2207/30201

(57) ABSTRACT

The present disclosure provides an electronic device in which EVS pixels can be arranged closer to a central part, and a method of controlling the electronic device.

An electronic device includes a display unit that has a display region in which display elements are arranged in an array in a first direction and a second direction different from the first direction, and an image sensor that is disposed on a side opposite to a display surface of the display unit so as to overlap the display region in a third direction different from be first direction and the second direction, and includes a plurality of pixels. The display unit transmits incident light, and the plurality of pixels outputs an event signal in a case where a change in luminance of light incident via the display unit is larger than a predetermined threshold.

### TECHNICAL FIELD

The present disclosure relates to an electronic device and a method of controlling the electronic device.

### BACKGROUND ART

A synchronous solid-state image sensor that captures image data (frame) in synchronization with a synchronization signal such as a vertical synchronization signal has been used in an electronic device or the like. With this general synchronous solid-state image sensor, image data can be acquired only at every synchronization signal cycle (e.g., 1/60 second). Hence, it is difficult to deal with requests for higher-speed processing in fields such as traffic and robots. Therefore, an asynchronous solid-state image sensor has been proposed in which a detection circuit that detects, for each pixel address, that the light amount of the pixel exceeds a threshold as an address event in real time is provided for each pixel. Such a solid-state image sensor that detects an address event for each pixel is called an event base vision sensor (EVS).

### CITATION LIST

### Patent Document

Patent Document 1: WO 2019/087471 A

Patent Document 2: Japanese Patent Application Laid-Open No. 2017-169987

### SUMMARY OF THE INVENTION

### Problems to be Solved by the Invention

Meanwhile, the state of a front part of an electronic device may be observed by an EVS image based on detection signals generated by EVS pixels. However, the EVS pixels are arranged at an end of a front surface part of the electronic device, and there is a risk that occlusion or the like is likely to occur.

Therefore, the present disclosure provides an electronic device in which EVS pixels can be arranged closer to a central part, and a method of controlling the electronic device.

### Solution to Problems

In order to solve the above problem, according to the present disclosure, there is provided an electronic device including a display unit that has a display region in which display elements are arranged in an array in a first direction and a second direction different from the first direction, and an image sensor that is disposed on a side opposite to a display surface of the display unit so as to overlap the display region in a third direction different from the first direction and the second direction, and includes a plurality of pixels, in which the display unit transmits incident light, and the plurality of pixels outputs an event signal in a case where a change in luminance of light incident via the display unit is larger than a predetermined threshold.

The electronic device may further include a state analysis unit that analyzes a behavior of a user in a contact operation on the display unit using information of the event signal and estimates a user feeling.

The electronic device may further include a contact position analysis unit that estimates a position at which the user has contacted the display unit by using information of the event signal.

The contact position analysis unit may use propagation information of the event signal to distinguish an object that touched the display unit.

The electronic device may further include a control unit that controls the display unit, and may change a display content to be displayed on the display unit according to at least one of the contact position or the touched object.

A display content to be displayed on the display unit may be changed on the basis of a vibration image of a user generated using information of the event signal.

The electronic device may further include a state analysis unit that estimates a user's emotion on the basis of the vibration image of a user generated using information of the event signal.

The electronic device may further include a state processing unit that causes the display unit to display an image according to an estimation result of the state analysis unit.

The state processing unit may cause the display unit to display an image for healthcare according to an estimation result of the state analysis unit.

The state processing unit may cause the display unit to display a content option according to an estimation result of the state analysis unit.

The state processing unit may cause the display unit to display an action proposal to the user according to an estimation result of the state analysis unit.

The action proposal may be based on information of an improvement example of a third party acquired from an external server.

The electronic device may further include a speaker unit that emits a sound, and a sound arrival position analysis unit that estimates a part of the user exposed to the sound emitted from the speaker unit, using information of the event signal.

The sound arrival position analysis unit may determine whether or not an ear of a user is exposed to a sound emitted from the speaker unit.

The electronic device may further include a sound wave direction adjustment unit that controls an orientation of the speaker according to an arrival position of a sound analyzed by the sound arrival position analysis unit.

The electronic device may further include a face shape analysis unit hat records three-dimensional position information of both eyes, both ears, a nose, and a mouth in a three-dimensional image of the user in a recording unit.

The face shape analysis unit may estimate a position of an ear in three images in an oblique direction of the user by using three-dimensional position information of both eyes, both ears, a nose, and a mouth of the user recorded in advance and a rotation angle of the three-dimensional image of the user.

The sound arrival position analysis unit may be able to change an arrival position extracted by analysis according to an audio wavelength, of the speaker.

In a case where the sound arrival position analysis unit determines that a sound reaches the user the basis of the event signal, a depth sensor that captures a three-dimensional image of the user may be activated.

The sound arrival position analysis unit may fuse an image based on the event signal and an image based on the depth sensor, and acquire three-dimensional position information of both eves, both ears, a nose, and a mouth of the user.

The face shape analysis unit may generate a three-dimensional image of the user by skeleton estimation after activation of the depth sensor.

The event signal may be acquired constantly.

The display unit may be caused to emit light so as to satisfy sensitivity of the plurality of pixels.

According to the present disclosure, there is provided a method of controlling an electronic device including a display unit that has a display region in which display elements are arranged in an array in a first direction and a second direction different from the first direction, and an image sensor that is disposed on a side opposite to a display surface or the display unit so as to overlap the display region in a third direction different from the first direction and the second direction, and includes a plurality of pixels, in which the display unit transmits incident light, and the plurality of pixels outputs an event signal in a case where a change in luminance of light incident via the display unit is larger than a predetermined threshold.

### BRIEF DESCRIPTION OF DRAWINGS

FIG. 1 is a block diagram illustrating a configuration example of an electronic device of an embodiment of the present technology.

FIG. 2 is a diagram illustrating an example of a laminated structure of a solid-state image sensor of the embodiment of the present technology.

FIG. 3 is a schematic cross-sectional view of an electronic device according to a first embodiment.

FIG. 4 is a schematic external view of the electronic device of FIG. 1.

FIG. 5 is a block diagram illustrating a configuration example of a solid state image sensor.

FIG. 6 is a diagram schematically illustrating pixel blocks 30a arranged in a matrix in a pixel array unit.

FIG. 7 is a diagram schematically illustrating a configuration of a pixel block.

FIG. 8 is a block diagram illustrating a configuration example of an AD converter.

FIG. 9 is a block diagram illustrating a configuration example of another AD converter.

FIG. 10 is a diagram illustrating a configuration example of a gradation pixel.

FIG. 11 is a diagram illustrating a configuration example of an EVS pixel.

FIG. 12 is a block diagram illustrating a first configuration example of an EVS AFE.

FIG. 13 is a circuit diagram illustrating an example of a configuration of a current-voltage conversion unit.

FIG. 14 is a circuit diagram illustrating an example of configurations of a subtractor and a quantizer.

FIG. 15 is a block diagram illustrating a second configuration example of an EVS AFE.

FIG. 16 is a block diagram illustrating a configuration example of an analysis unit.

FIG. 17 is a schematic diagram in which movement of a fingertip region is imaged via a display unit.

FIG. 18 is a diagram illustrating an example of data used for analysis by a state analysis unit.

FIG. 19 is a flowchart illustrating a processing example of a second embodiment.

FIG. 20 is a block diagram illustrating a configuration example of an analysis unit according to a third embodiment.

FIG. 21 is a diagram in which time-series images of a first EVS image when a cover glass is touched are displayed in a superimposed manner.

FIG. 22 is a block diagram illustrating a configuration example of an analysis unit according to a fourth embodiment.

FIG. 23 is a diagram illustrating face regions recognized by a recognition processing unit.

FIG. 24 is a schematic diagram illustrating a change in position of a lower jaw part of the face in time series.

FIG. 25 is a block diagram illustrating a configuration example of an analysis unit according to a fifth embodiment.

FIG. 26 is a diagram schematically illustrating a server that supplies content to an electronic device.

FIG. 27 is a diagram illustrating an example of first EVS images captured in time series.

FIG. 28 is a diagram schematically illustrating a vibration image generated by a vibration image generation unit.

FIG. 29 is a diagram illustrating an example of an image displayed by a state processing unit.

FIG. 30 is a diagram illustrating another example of an image displayed by the state processing unit.

FIG. 31 is a diagram illustrating an example of an image using external information displayed by the state processing unit.

FIG. 32 is a diagram schematically illustrating a recording state of an estimation result in a state analysis unit.

FIG. 33 is a diagram schematically illustrating a recording state of an estimation result in the state analysis unit in a second mode.

FIG. 34 is a flowchart illustrating a flow of user state analysis using a vibration image of a user.

FIG. 35 is a flowchart illustrating a flow of user state analysis at the time of content display.

FIG. 36 is a block diagram illustrating a configuration example of an analysis unit according to a sixth embodiment.

FIG. 37 is a view schematically illustrating a sensor configuration of an electronic device according to the sixth embodiment.

FIG. 38 is a diagram schematically illustrating a vertical cross section of a speaker unit of an electronic device according to the sixth embodiment.

FIG. 39A is a diagram illustrating a three-dimensional image of the front of a user captured by a depth sensor.

FIG. 39B is a diagram illustrating a three-dimensional image of the user in an oblique direction.

FIG. 39C is an image obtained by rotating the three-dimensional image of the front of the user so as to match the three-dimensional image in the oblique direction.

FIG. 39D is a diagram in which a position of an ear is acquired using a rotation angle and three-dimensional position information of both eyes, both ears, the nose, and the mouth.

FIG. 40A is a diagram illustrating first EVS images of the front of a user captured in time series.

FIG. 40B is a diagram illustrating first EVS images of the front of the user captured in time series after sound wave direction adjustment.

FIG. 40C is a diagram illustrating first EVS images of the user in an oblique direction captured in time series.

FIG. 40D is a diagram illustrating first EVS images of the user in an oblique direction captured in time series after sound wave direction adjustment.

FIG. 41 is a flowchart illustrating a flow of a processing example of changing the direction of a sound.

### MODES FOR CARRYING OUT THE INVENTION

Hereinafter, embodiments of an electronic device and a method of controlling the electronic device will be described with reference to the drawings. While main components of the electronic device will be mainly described below, the electronic device can have components and functions that are not illustrated or described. The following description does not exclude components and functions that are not illustrated or described.

### First Embodiment

### Configuration Example of Electronic Device

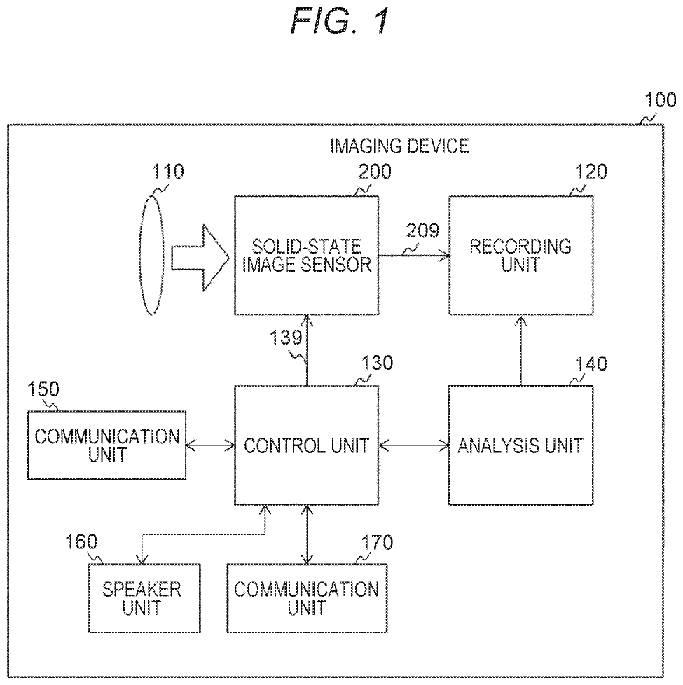

FIG. 1 is a block diagram illustrating a configuration example of an electronic device 100 of an embodiment of the present technology. The electronic device 100 includes an imaging lens 110, a solid-state image sensor 200, a recording unit 120, a control unit 130, a miracle unit 140, a communication unit 150, and a speaker unit 160. The electronic device 100 is, for example, a smartphone, a mobile phone, a personal computer (PC), or the like.

The imaging lens 110 collects incident light and guides it to the solid-state image sensor 200. The solid-state image sensor 200 includes an EVS pixel and a gradation pixel. The EVS pixel can detect that the absolute value of the luminance change amount exceeds a threshold as an address event. The address event includes, for example, an on-event indicating that the amount of increase in luminance exceeds the upper limit threshold and an off-event indicating that the amount of decrease in luminance falls below le lower limit threshold less than the upper limit threshold. Then, the solid-state image sensor 200 generates a detection signal indicating the detection result of the address event for each EVS pixel. Each of the detection signals includes an on-event detection signal VCH indicating presence or absence of an on-event and an off-event detection signal CL indicating presence or absence of an off-event. Note that while the solid-state image sensor 200 detects the presence or absence of both the on-event and the off-event, it is also possible to detect only one of the on-event and the off-event. Furthermore, be EVS pixel according to the present embodiment can output an EVS luminance signal in addition to the detection signal. As a result, a first EVS image based on the detection signal of the EVS pixel and a second EVS image based on the luminance signal of the EVS pixel are formed.

On the other hand, the gradation pixel outputs a gradation luminance signal. A gradation image is formed on the basis of the gradation luminance signal output from the gradation pixel. Note that in the present embodiment, an image based on the detection signal of the EVS pixel is referred to as the first EVS image, an image based on the luminance signal of the EVS pixel is referred to as the second EVS image, and an image based on the gradation luminance signal output from the gradation pixel is referred to as a gradation image. The present embodiment has a first mode in which both the gradation pixel and the EVS pixel are driven, and a second mode and a third mode in which only the EVS pixel is driven. The second mode is a mode in which the first EVS image based on the detection signal of the EVS pixel and the second EVS image based on the luminance signal of the EVS pixel are formed. On the other hand, the third mode is a mode in which the first EVS image based on the detection signal of the EVS pixel is formed. Since the gradation pixel and the EVS pixel can be driven independently, the gradation pixel can be imaged at an imaging rate of, for example, 60 fps, whereas the second mode can be imaged at a rate of, for example, 200 fps. Further, in the third mode, since the luminance signal is not read from the EVS pixel, imaging can be performed at an even higher frame rate.

Power consumption is the smallest in the third mode, and is the next smallest in the second mode. Therefore, the EVS pixels are always driven in the third mode, and it is possible to perform state monitoring or the like based on the first EVS image based on the detection signal of the EVS pixels.

The solid-state image sensor 200 performs predetermined signal processing such as image processing on the first EVS image, the second EVS image, and the gradation image, and outputs the processed data to the recording unit 120 via a signal line 209.

The recording unit 120 records the data and the like from the solid-state image sensor 200. The control unit 130 controls the entire electronic device 100. For example, the control unit 130 controls the solid-state image sensor 200 to capture image data.

The analysis unit 140 performs predetermined analysis processing using at least one of the first EVS image, the second EVS image, or the gradation image.

The communication unit 150 performs wireless communication with an external device. As a result, content or the like is received from an external server and recorded in the recording unit 120 via the control unit 130. For example, the control unit 130 causes a display unit 170 to display an image based on the content.

The speaker unit 160 includes a highly directional speaker and can transmit sound information only to the user. The speaker unit 160 can change the direction in which the sound is transmitted.

### Configuration Example of Solid-State Image Sensor

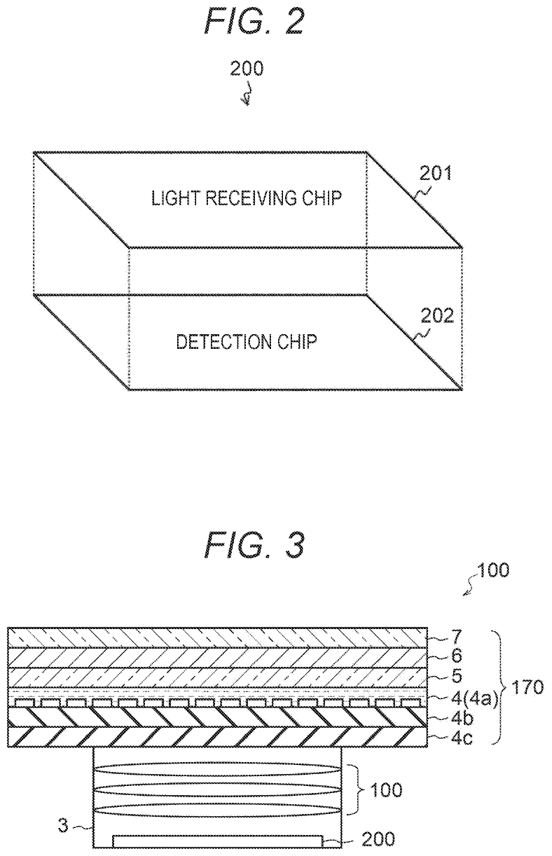

FIG. 2 is a diagram illustrating an example of a laminated structure of the solid-state image sensor 200 of the embodiment of the present technology. The solid-state image sensor 200 includes a detection chip 202 and a light receiving chip 201 laminated on the detection chip 202. These substrates are electrically connected through a connection part such as a via. Note that other than vias, Cu—Cu bonding or bumps can be used for connection.

FIG. 3 is a schematic cross-sectional view of the electronic device 100 according to a first embodiment. This is an example of the electronic device 100 having an optical system 110, and is any electronic device haying both a display function and an imaging function, such as a smartphone, a mobile phone, a tablet, a bar code reader, and a PC. A camera module 3 disposed on the side opposite to a display surface of the display unit 170 is provided. That is, the optical system 110 and the solid-state image sensor 200 are arranged in the camera module 3. As described above, in the electronic device 1 of FIG. 1, the camera module 3 is provided on the back side of the display surface of the display unit 170. Therefore, the camera module 3 performs imaging through the display unit 170. As described above, since the camera module 3 can be installed near the center of the electronic device 100, occlusion can be reduced. Moreover, it is also possible to increase the sensitivity by using the light emission of the display unit 170 itself. Furthermore, since the camera module 3 is provided on the back side of the display surface of the display unit 170, a spatial margin for increasing the thickness of the optical system 110 can be provided. As a result, a fisheye lens or the like can be used for the optical system 110, and a wide range of images can be acquired.

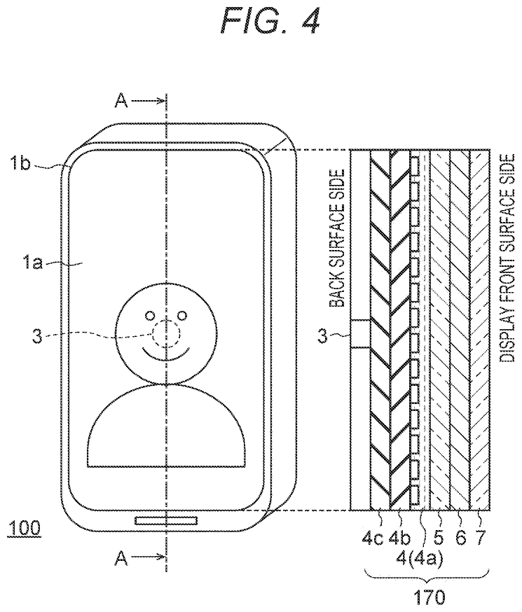

FIG. 4 is a schematic external view of the electronic device 100 of FIG. 1, the left diagram is an external view on the display unit 170 side, and the right diagram is a cross-sectional view of the display unit 170 taken along line A-A. While a display screen 1a spreads to the vicinity of the outer size of the electronic device 100 in the illustration of the example of FIG. 4 a front camera and a depth sensor (not illustrated) are mounted on a bezel 1b.

Note that while the camera module 3 is disposed on the back surface side of a substantially central part of the display screen 1a in FIG. 4, in the present embodiment, the camera module 3 may be disposed anywhere, as long as it is on the back surface side of the display 10 screen 1a. In this manner, the camera module 3 in the present embodiment is disposed at an arbitrary position on the back surface side overlapping the display screen 1a.

As illustrated in FIG. 4, the display unit 170 has a structure in which a polarizing plate 4c, a ¼ wave plate 4b, a display panel 4 (4a), a touch panel 5, a circularly polarizing plate 6, and a cover glass 7 (which may include a touch panel) are stacked in this order. The circularly polarizing plate 6 includes a polarizing plate 6a and a ¼ wave plate 6b as described later.

The polarizing plate 4c and the ¼ wave plate 4b curb incidence of internally reflected light on the camera module 3. In the display and 4, display elements are arranged in an array. The display panel 4 may be, for example, an organic light emitting device (OLED) diode, a liquid crystal display unit, a MicroLED, or a display panel based on other display principles.

The display panel 4 such as an OLED unit includes a plurality of layers. The display panel 4 is often provided with a member having low transmittance such as a color filter layer. A through hole may be formed in the member having a low transmittance in the display panel 4 in accordance with the arrangement place of the camera module 3. If object light passing through the through hole is made incident on the camera module 3, the image quality of the image captured by the camera module 3 can be improved.

The circularly polarizing plate 6 is provided to reduce glare and enhance visibility of the display screen 1a even in a bright environment. A touch sensor is incorporated in the touch panel 5. While there are various types of touch sensors such as a capacitive type and a resistive film type, any type may be used. Furthermore, the touch panel 5 and the display panel 4 may be integrated. The cover glass 7 is provided to protect the display panel 4 and other components.

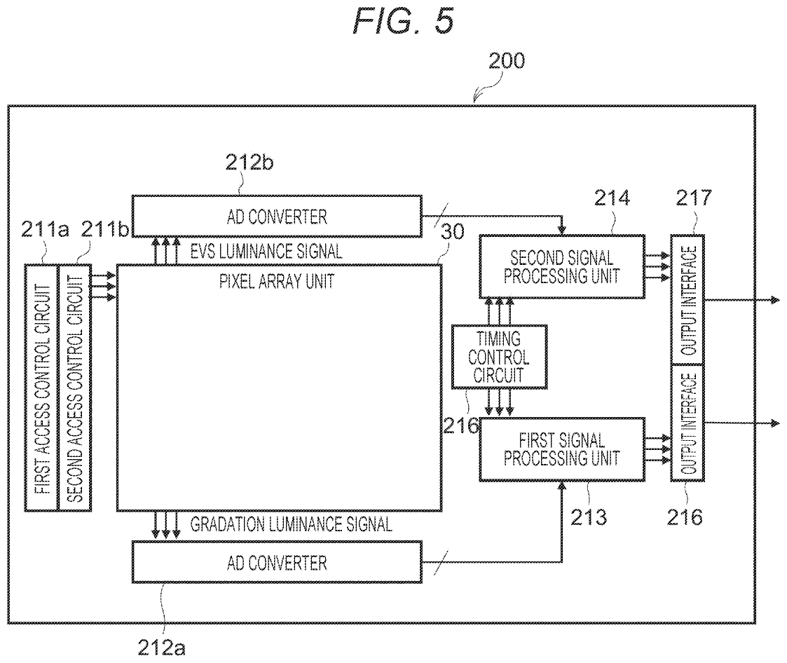

FIG. 5 is a block diagram illustrating a configuration example of the solid-state image sensor 200. As illustrated in FIG. 5, the solid-state image sensor 200 according to the present disclosure is a device called EVS which is capable of performing asynchronous imaging and synchronous imaging for a gradation image in parallel. The solid-state image sensor 200 includes a pixel array unit 30, a first access control circuit 211a, a second access control circuit 211b, an AD converter 212a, an AD converter 212b, a first signal processing unit 213, a second signal processing unit 214, a timing control circuit 215, and output interfaces 216 and 217.

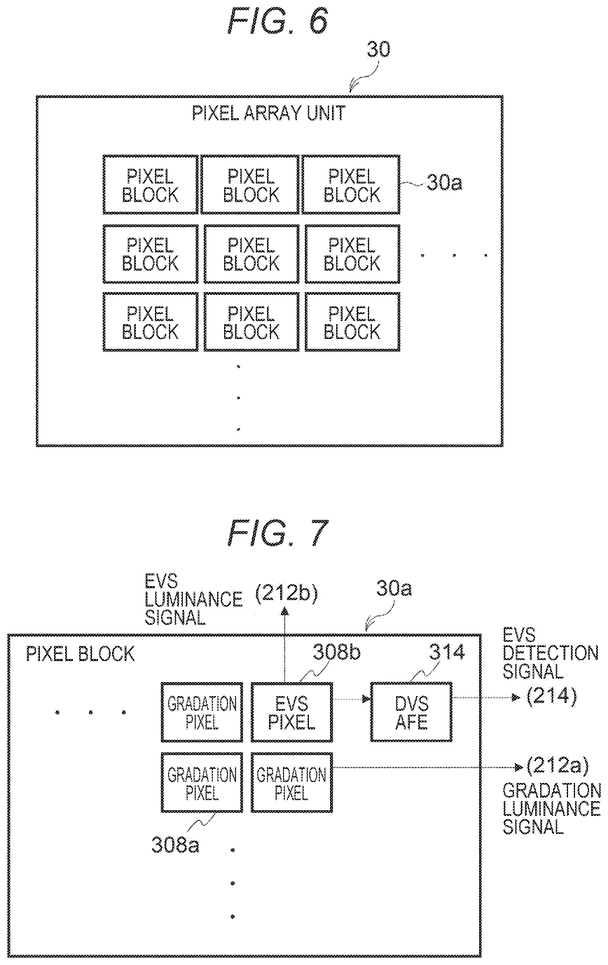

Here, a configuration of the pixel array unit 30 will be described with reference to FIGS. 6 and 7. FIG. 6 is a diagram schematically illustrating pixel blocks 30a arranged in a matrix in the pixel array unit 30. As illustrated in FIG. 6, in the pixel array unit 30, a plurality of pixel blocks 30a is two-dimensionally arranged in a matrix (array).

A configuration of the pixel block 30a will be described with reference to FIG. 7. FIG. 7 is a diagram schematically illustrating a configuration of the pixel block 30a. As illustrated in FIG. 7, the pixel block 30a includes a plurality of gradation pixels 308a, an EVS pixel 308b, and an EVS analog front end (AFE) 314. In the pixel block 30a, the plurality of gradation pixels 308a and the EVS pixel 308b are arranged in a matrix. In this pixel array, a vertical signal line VSL1 to be described later is wired for each pixel column of the gradation pixels 308a. Furthermore, a vertical signal line VSL2 independent of the vertical signal line VSL1 is wired for each pixel column of the EVS pixels 308b. Each of the plurality of gradation pixels 308 generates an analog signal of a voltage corresponding to the photocurrent as a gradation luminance signal (second luminance signal) and outputs the signal to the AD converter 212a (see FIG. 5).

In the first mode and the second mode, the EVS pixel 308b outputs an analog signal of a voltage corresponding to the photocurrent to the EVS AFE 314. Furthermore, the EVS pixel 308b generates an analog signal of a voltage corresponding to the photocurrent as an EVS luminance signal (first luminance signal), and outputs the signal to the AD converter circuit 212b (see FIG. 5) in a case where an address event occurs.

On the other hand, in the third mode, the EVS pixel 308b does not output the EVS luminance signal to the AD converter circuit 212b (see FIG. 5), and outputs the EVS luminance signal only to the EVS analog front end (AFE) 314.

The EVS analog front end (AFE) 314 generates a detection signal from a voltage signal based on the output of the EVS pixel 308b, and outputs the detection signal to the second signal processing unit 214 (see FIG. 3). More specifically, the EVS AFE 314 detects the presence or absence of an address event according to whether or not the change amount of the photocurrent in the EVS pixel 308b exceeds a predetermined threshold. Then, the EVS AFE 314 outputs the detection signal to the second signal processing unit 214. For example, the EVS AFE 314 outputs address information (X, Y), time stamp information T, and address event information VCH and VCL of the detected active pixel to the second signal processing unit 214 as, for example, event information (X, Y, T, VCH, VCL). Furthermore, the EVS AFE 314 is included in the detection chip 202. The plurality of gradation pixels 308a, the EVS pixel 308b, and the EVS AFE 314 can operate in parallel by an independent control system. Note that detailed configurations of the gradation pixel 308a, the EVS pixel 308b, and the EVS AFE 314 will be described later.

Returning to FIG. 5, the first access control circuit 211a controls the plurality of gradation pixels 308a. The first access control circuit 211a controls resetting of accumulated charges of each of the plurality of gradation pixels 308a, generation of a gradation luminance signal according to an accumulation amount or a photoelectric conversion current, output of a gradation luminance signal, and the like. For example, the first access control circuit 211a causes the AD converter 212a to sequentially output the photoelectric conversion current accumulated in each of the plurality of gradation pixels 308a as a gradation luminance signal for each row. Note that details of the control operation of the gradation pixel 308a will be described later.

The second access control circuit 211b controls the plurality of EVS pixels 308b and the plurality of EVS AFEs 314. The second access control circuit 211b according to the present embodiment causes the plurality of EVS AFEs 314 to sequentially detect address events for each row, and causes the second signal processing unit 214 to sequentially output the detection signals for each row.

Furthermore, when an address event is detected, the second access control circuit 211b sequentially outputs the luminance signals of the plurality of EVS pixels 308b to an EVS readout circuit 212b for each row.

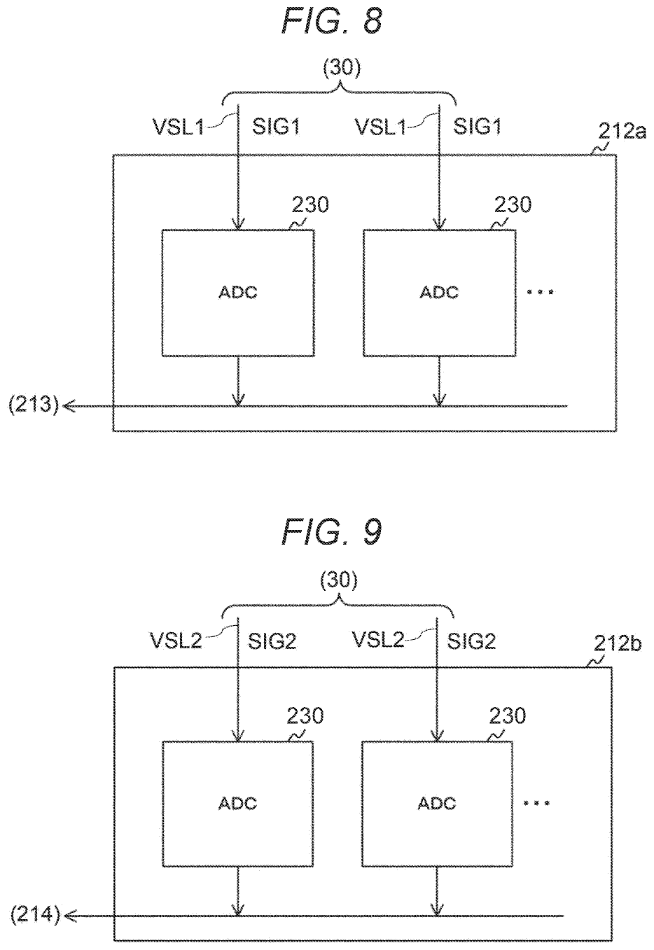

A configuration example of the AD converter 212a will be described with reference to FIG. 8. FIG. 8 is a block diagram illustrating a configuration example of the AD converter 212a. The AD converter 212a includes an ADC 230 for each column of the gradation pixels 308a arranged for each pixel block 30a. The ADC 230 converts an analog gradation luminance signal SIG supplied via the vertical signal line VSL1 into a digital signal. This digital signal is converted into a digital pixel signal having a bit depth larger than that of the gradation luminance signal SIG1. For example, assuming that the gradation luminance signal SIG1 is 2 bits, the pixel signal is converted into a digital signal of 3 bits or more (e.g., 16 bits). The ADC 230 supplies the generated digital signal to the first signal processing unit 213. Note that the region of the plurality of gradation pixels 308a in the pixel array unit 30 may be divided into a plurality of regions, and the AD converter 212a may read the gradation luminance signal SIG1 for each of the plurality of regions. As a result, the gradation luminance signal SIG1 can be read at a higher speed.

A configuration example of the AD converter 212b for EVS will be described with reference to FIG. 9. FIG. 9 is a block diagram illustrating a configuration example of the AD converter 212b. The AD converter 212b for EVS includes the ADC 230 for each column of the EVS pixels 308b arranged for each pixel block 307. The ADC 230 converts an analog EVS luminance signal SIG2 supplied via the vertical signal line VSL2 into a digital signal. This digital signal is converted into a digital pixel signal having a bit depth larger than that of the EVS luminance signal SIG2. For example, assuming that the EVS luminance signal SIG2 is 2 bits, the pixel signal is converted into a digital signal of 3 bits or more (e.g., 16 bits). The ADC 230 supplies the generated digital signal to the second signal processing unit 214.

Returning to FIG. 5, the first signal processing unit 213 per arms predetermined sig processing such as correlated double sampling (CDS) processing on the digital signal from the AD converter 212a. The signal processing unit 212 supplies data indicating a processing result and a detection signal to the recording unit 120 via the signal line 209.

The timing control circuit 215 controls the timing of each component of the solid-state image sensor 200 on the basis of time stamp information. For example, the timing control circuit 212d controls timings of the first access control circuit 211a and the second access control circuit 211b. As a result, is also possible to synchronize the luminance signal of the gradation pixel 308a read by the AD converter 212a with the EVS luminance signal of the EVS pixel 308b read by the EVS readout circuit 212b.

Returning to FIG. 5, the first signal processing unit 213 performs predetermined signal processing such as correlated double sampling (CDS) processing on the digital signal from the AID converter 212a. The signal processing unit 212 supplies data indicating a processing result and a detection signal to the recording unit 120 via the signal line 209. Furthermore, the first signal processing unit 213 generates image data in a predetermined data format from the digital signal from the AD converter 212a.

The second signal processing unit 214 performs predetermined signal processing on the detection signals from the plurality of EVS AFEs 314. The second signal processing unit 214 generates a first EVS image by, for example, arranging detection signals as pixel signals in a two-dimensional lattice pattern.

As illustrated in FIG. 5, the output interface 216 outputs the image data and the like supplied from the first signal processing unit 213 to the recording unit 120. Similarly, the output interface 217 outputs the image data and the like supplied from the second signal processing unit 214 to the recording unit 120.

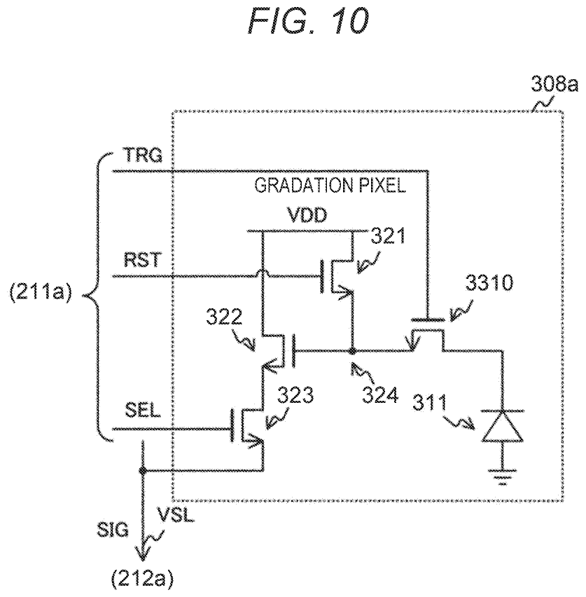

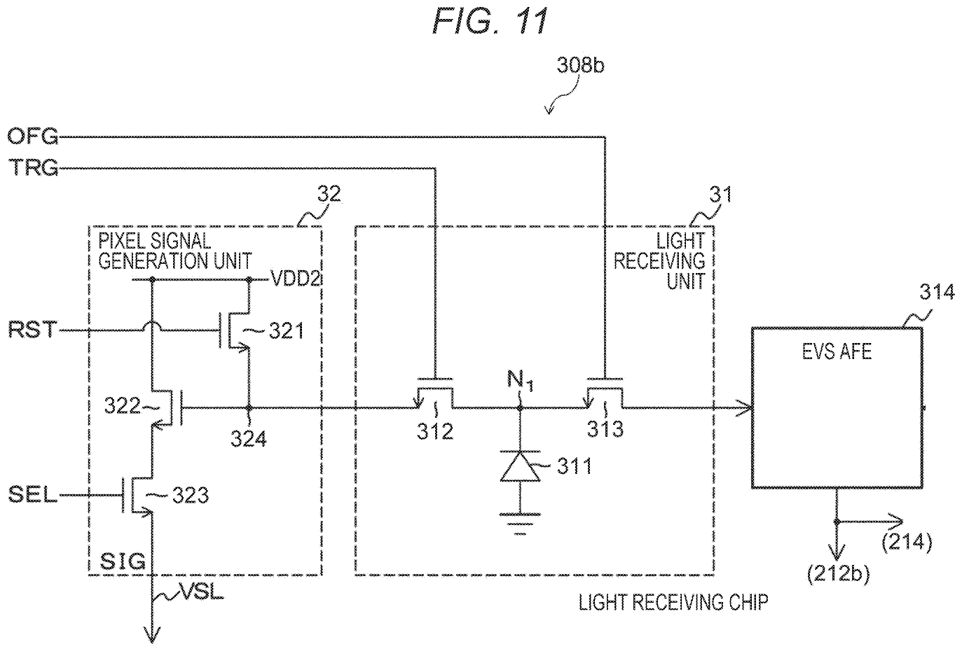

Here, a detailed configuration example and a control operation example of the gradation pixel 308a will be described with reference to FIG. 10. FIG. 10 is a diagram illustrating a configuration example of the gradation pixel 308a. As illustrated in FIG. 10, the gradation pixel 308a includes a reset transistor 321, an amplification transistor 322, a selection transistor 323, a floating diffusion layer 324, and a light receiving unit 330.

N-type metal-oxide-semiconductor (MOS) transistors are used as the reset transistor 321, the amplification transistor 322, the selection transistor 323, and a transfer transistor 3310, for example. Furthermore, a photoelectric conversion element 311 is disposed on the light receiving chip 201. All the elements other than the photoelectric conversion element 311 are arranged on the detection chip 202.

The photoelectric conversion element 311 photoelectrically converts incident light to generate charge.

The charge photoelectrically converted by the photoelectric conversion element 311 is supplied from the photoelectric conversion element 311 to the floating diffusion layer 324 by the transfer transistor 3310. The charge supplied from the photoelectric conversion element 311 is accumulated in the floating diffusion layer 324. The floating diffusion layer 324 generates a voltage signal having a voltage value corresponding to the amount of accumulated charges.

The amplification transistor 322 is connected in series with the selection transistor 323 between the power line of a power supply voltage VDD and the vertical signal line VSL1. The amplification transistor 322 amplifies the voltage signal subjected to charge-voltage conversion by the floating diffusion layer 324.

A selection signal SEL is supplied from the first access control circuit 211a to the gate electrode of the selection transistor 323. In response to the selection signal SEL, the selection transistor 323 outputs the voltage signal amplified by the amplification transistor 322 to the AD converter 212a (see FIG. 5) via the vertical signal line VSL1 as the pixel signal SIG.

### Circuit Configuration Example of EVS Pixel

Here, a detailed configuration example of the EVS pixel 308b will be described with reference to FIG. 11. FIG. 11 is a diagram illustrating a configuration example of the EVS pixel 308b. Each of the plurality of EVS pixels 308b includes a light receiving unit 31, a pixel signal generation unit 32, and the EVS AFE 314.

In the EVS pixel 308b having the above configuration, the light receiving unit 31 includes a light receiving element (photoelectric conversion element) 311, a transfer transistor 312, and an OFG (Over Flow Gate) transistor 313. N-type metal oxide semiconductor (MOS) transistors are used as the transfer transistor 312 and the OFG transistor 313, for example. The transfer transistor 312 and the OFG transistor 313 are connected in series to each other.

The light receiving element 311 is connected between a common connection node N1 of the transfer transistor 312 and the OFG transistor 313 and the ground, and photoelectrically converts incident light to generate charge of a charge amount corresponding to the amount of the incident light.

A transfer signal TRG is supplied from the second access control circuit 21 illustrated in FIG. 2 to the gate electrode of the transfer transistor 312. In response to the transfer signal TRG, the transfer transistor 312 supplies the charge photoelectrically converted by the light receiving element 311 to the pixel signal generation unit 32.

A control signal OFG is supplied from the second access control circuit 211b to the gate electrode of the OFG transistor 313. In response to the control signal OFG, the OFG transistor 313 supplies the electric signal generated by the light receiving element 311 to the EVS AFE 314. The electric signal supplied to the EVS ATE 314 is a photocurrent including charges.

The pixel signal generation unit 32 includes a reset transistor 321, an amplification transistor 322, a selection transistor 323, and a floating diffusion layer 324. N-type MOS transistors are used as the reset transistor 321, the amplification transistor 322, and the selection transistor 323, for example.

The charge photoelectrically converted by the light receiving element 311 is supplied from the light receiving unit 31 to the pixel signal generation unit 32 by the transfer transistor 312. The charge supplied from the light receiving unit 31 is accumulated in the floating diffusion layer 324. The floating diffusion layer 324 generates a voltage signal having a voltage value corresponding to the amount of accumulated charges. That is, the floating diffusion layer 324 converts charge into voltage.

The reset transistor 321 is connected between the power line of the power supply voltage VDD and the floating diffusion layer 324. A reset signal RST is supplied from the second access control circuit 211b to the gate electrode of the reset transistor 321. The reset transistor 321 initializes (resets) the charge amount of the floating diffusion layer 324 in response to the reset signal RST.

The amplification transistor 322 is connected in series with the selection transistor 323 between the power line of the power supply voltage VDD and the vertical signal line VSL. The amplification transistor 322 amplifies the voltage signal subjected to charge-voltage conversion by the floating diffusion layer 324.

A selection signal SEL is supplied from the second access control circuit 211b to the gate electrode of the selection transistor 323. In response to the selection signal SEL, the selection transistor 323 outputs, the voltage signal amplified by the amplification transistor 322 to the EVS readout circuit 212b (see FIG. 2) via the vertical signal line VSL as the pixel signal SIG.

In the electronic device 100 including the pixel array unit 30 in which the EVS pixels 308b having the above-described configuration are two-dimensionally arranged, when the control unit 130 illustrated in FIG. 1 instructs to start detection of an address event, the second access control circuit 211b supplies a control signal OFG to the OFG transistor 313 of the light receiving unit 31, thereby driving the OFG transistor 313 to supply photocurrent to the EVS AFE 314.

Then, when an address event is detected in a certain EVS pixel 308b, the second access control circuit 211b turns off the OFG transistor 313 of the EVS pixel 308b to stop the supply of photocurrent to the EVS AFE 314. Next, the second access control circuit 211b supplies a transfer signal TRG to the transfer transistor 312 to drive the transfer transistor 312, and transfers the charge photoelectrically converted by the light receiving element 311 to the floating diffusion layer 324.

In this manner, the electronic device 100 including the pixel array unit 30 in which the EVS pixels 308b having the above-described configuration are two-dimensionally arranged outputs only the pixel signal of the EVS pixel 308b in which the address event is detected to the EVS readout circuit 212b. As a result, regardless of the presence or absence of an address event, power consumption of the electronic device 100 and the processing amount of image processing can be reduced as compared with the case of outputting the pixel signals of all the pixels.

Note that the configuration of the EVS pixel 308b exemplified here is an example, and the EVS pixel 308b is not limited to this configuration example. For example, the pixel configuration may omit the pixel signal generation unit 32. In the case of this pixel configuration, it is only required that the OFG transistor 313 be omitted from the light receiving unit 31, and the transfer transistor 312 have the function of the OFG transistor 313.

### First Configuration Example of EVS AFE

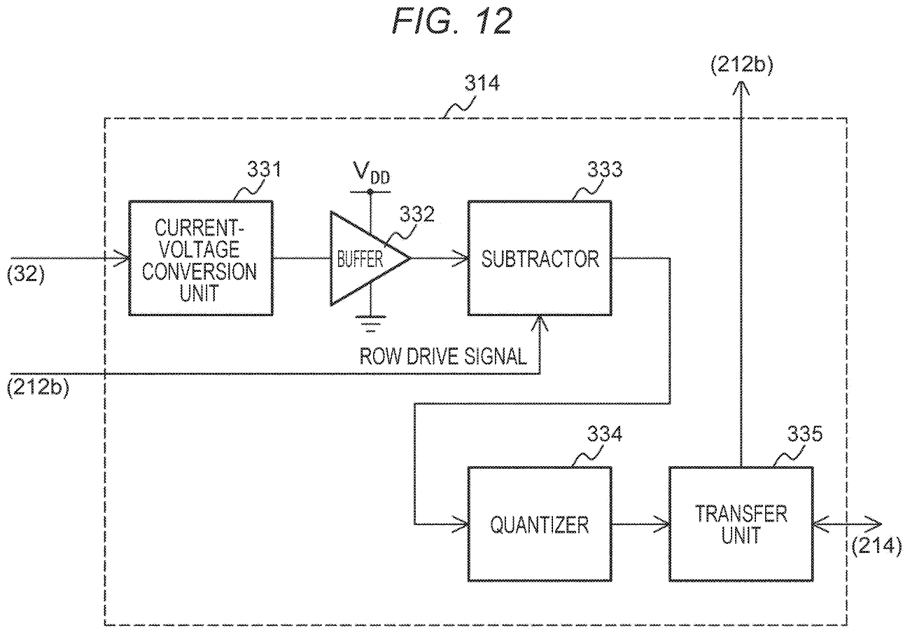

FIG. 12 is a block diagram illustrating a first configuration example of the EVS AFE 314. As illustrated in FIG. 12, the EVS AFE 314 according to the present configuration example includes a current-voltage conversion unit 331, a buffer 332, a subtractor 333, a quantizer 334, and a transfer unit 335.

The current-voltage conversion unit 331 converts the photocurrent from the light receiving unit 31 of the gradation pixel 308a into a logarithmic voltage signal. The current-voltage conversion unit 331 supplies the converted voltage signal to the buffer 332. The buffer 332 buffers the voltage signal supplied from the current-voltage conversion unit 331 and supplies the voltage signal to the subtractor 333.

A row drive signal is supplied from the second access control circuit 211b to the subtractor 333. The subtractor 333 lowers the level of the voltage signal supplied from the buffer 332 in accordance with the row drive signal. Then, the subtractor 333 supplies the voltage signal with lowered level to the quantizer 334. The quantizer 334 quantizes the voltage signal supplied from the subtractor 333 into a digital signal and outputs the digital signal to the transfer unit 335 as an address event detection signal.

The transfer unit 335 transfers the address event detection signal supplied from the quantizer 334 to the second signal processing unit 214 and other components. When an address event is detected, the transfer unit 335 supplies an address event detection signal to the second signal processing unit 214 and the second access control circuit 211b.

Next, configuration examples of the current-voltage conversion unit 331, the subtractor 333, and the quantizer 334 in the EVS AFE 314 will be described.

### Configuration Example of Current-Voltage Conversion Unit

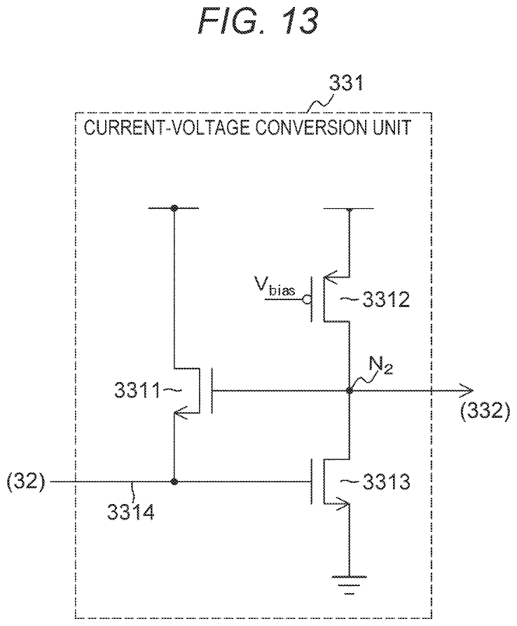

FIG. 13 is a circuit diagram illustrating an example of a configuration of the current-voltage conversion unit 331 in the EVS AFE 314. As illustrated in FIG. 13, the current-voltage conversion unit 331 according to the present example has a circuit configuration including an N-type transistor 3311, a P-type transistor 3312, and an N-type transistor 3313. For example, MOS transistors are used as these transistors 3311 to 3313.

The N-type transistor 3311 is connected between the power line of the power supply voltage VDD and a signal input line 3314. The P-type transistor 3312 and the N-type transistor 3313 are connected in series between the power line of the power supply voltage VDD and the ground. Then, a common connection node N2 of the P-type transistor 3312 and the N-type transistor 3313 is connected to the gate electrode of the N-type transistor 3311 and the input terminal of the buffer 332 illustrated in FIG. 11.

A predetermined bias voltage Vbias is applied to the gate electrode of the P-type transistor 3312. With this configuration, the P-type transistor 3312 supplies a constant current to the N-type transistor 3313. A photocurrent is input from the light receiving unit 31 to the gate electrode of the N-type transistor 3313 through the signal input line 3314.

The drain electrodes of the N-type transistor 3311 and the N-type transistor 3313 are connected to the power supply side, and such a circuit is called a source follower. These two source followers connected in a loop convert the photocurrent from the light receiving unit 31 into a logarithmic voltage signal.

### Configuration Examples of Subtractor and Quantizer

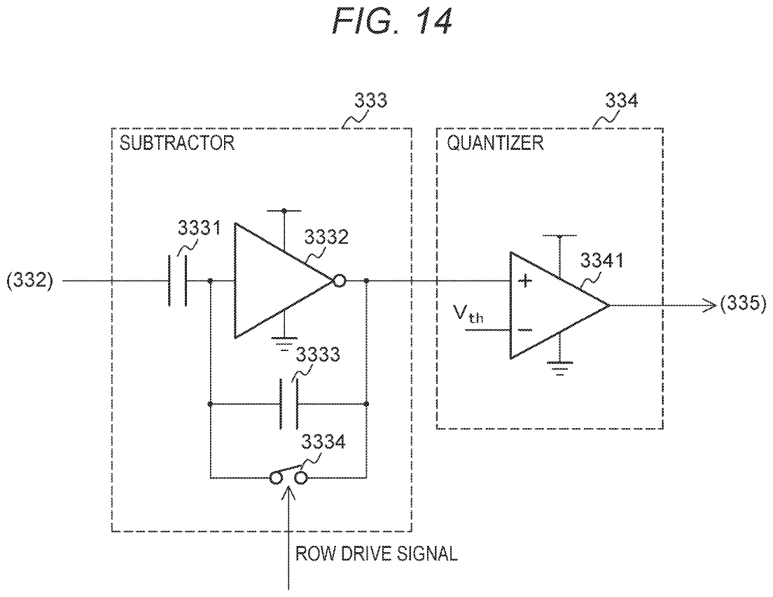

FIG. 14 is a circuit diagram illustrating an example of configurations of the subtractor 333 and the quantizer 334 in the EVS AFE 314.

The subtractor 333 according to the present example includes a capacitive element 3331, an inverter circuit 3332, a capacitive element 3333, and a switch element 3334.

One end of the capacitive element 3331 is connected to the output terminal of the buffer 332 illustrated in FIG. 14, and the other end of the capacitive element 3331 is connected to the input terminal of the inverter circuit 3332. The capacitive element 3333 is connected in parallel to the inverter circuit 3332. The switch element 3334 is connected between both ends of the capacitive element 3333. A row drive signal is supplied from the second access control circuit 211b to the switch element 3334 as an opening/closing control signal thereof. The switch element 3334 opens and closes a path connecting both ends of the capacitive element 3333 according to the row drive signal. The inverter circuit 3332 inverts the polarity of the voltage signal input via the capacitive element 3331.

In the subtractor 333 having the above configuration, when the switch element 3334 is turned on (closed), a voltage signal Vinit is input to the terminal of the capacitive element 3331 on the buffer 332 side, and the terminal on the opposite side becomes a virtual ground terminal. The potential of the virtual ground terminal is set to zero for convenience. At this time, when the capacitance value of the capacitive element 3331 is C1, charge Qinit accumulated in the capacitive element 3331 is expressed by the following formula (1). On the other hand, since both ends of the capacitive element 3333 are short-circuited, the accumulated charge is 0.

Qinit=C1×Vinit (1)

Next, considering a case where the switch element 3334 is turned off (open) and the voltage of the terminal of the capacitive element 3331 on the buffer 332 side changes to Vafter, charge Qafter accumulated in the capacitive element 3331 is expressed by t e following formula (2).

Qafter=C1×Vafter (2)

On the other hand, when the capacitance value of the capacitive element 3333 is C2 and the output voltage is Vout, charge Q2 accumulated in the capacitive element 3333 is expressed by the following formula (3).

Q2=−C2×Vout (3)

At this time, since the total charge amount of the capacitive element 3331 and the capacitive element 3333 does not change, the following formula (4) is established.

Qinit=Qafter+Q2 (4)

When the formulae (1) to (3) are substituted into the formula (4) and deformed, the following formula (5) is obtained.

Vout=−(C1/C2)×(Vafter−Vinit) (5)

The formula (5) represents the subtraction operation of the voltage signal, and the gain of the subtraction result is C1/C2. Since it is usually desired to maximize the gain, it is preferable to design C1 to be large and C2 to be small. On the other hand, when C2 is too small, kTC noise increases, and noise characteristics may deteriorate. Therefore, capacity reduction of C2 is limited to a range in which noise can be tolerated. Furthermore, since the EVS AFE 314 including the subtractor 333 is mounted for each EVS pixel 308b, the capacitive element 3331 and the capacitive element 3333 have area restrictions. In consideration of these, the capacitance values C1 and C2 of the capacitive elements 3331 and 3333 are determined.

In FIG. 14, the quantizer 334 includes a comparator 3341. The comparator 3341 takes the output signal of the inverter circuit 3332, that is, the voltage signal from the subtractor 333 as a non-inverting (+) input, and takes a predetermined threshold voltage Vth as an inverting (−) input. Then, the comparator 3341 compares the voltage signal from the subtractor 333 with the predetermined threshold voltage Vth, and outputs a signal indicating the comparison result to the transfer unit 335 as an address event detection signal.

### Second Configuration Example of EVS AFE

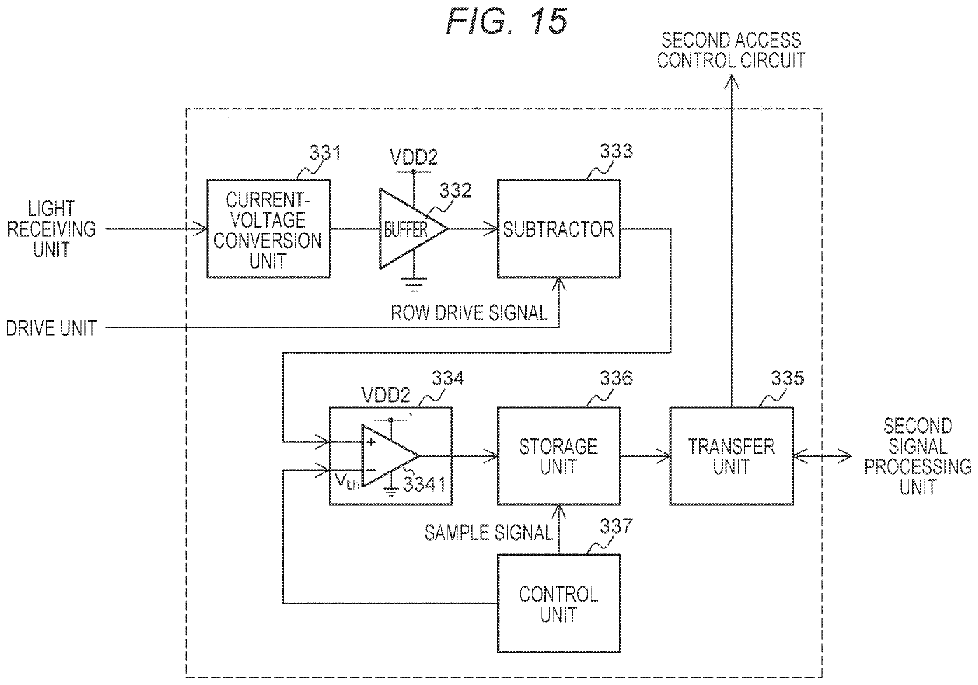

FIG. 15 is a block diagram illustrating a second configuration example of the EVS AFE 14. As illustrated in FIG. 15, the EVS AFE 314 according to the present configuration example includes a storage unit 336 and a control unit 337 in addition to the current-voltage conversion unit 331, the buffer 332, the subtractor 333, the quantizer 334, and the transfer unit 335.

The storage unit 336 is provided between the quantizer 334 and the transfer unit 335, and accumulates the output of the quantizer 334, that is, the comparison result of the comparator 3341 on the basis of a sample signal supplied from the control unit 337. The storage unit 336 may be a sampling circuit such as a switch, plastic, or a capacitor, or may be a digital memory circuit such as a latch or a flip-flop.

The control unit 337 supplies a predetermined threshold voltage Vth to the inverting (−) input terminal of the comparator 3341. The threshold voltage Vth supplied from the control unit 337 to the comparator 3341 may have different voltage values in a time division manner. For example, the control unit 337 supplies a threshold voltage Vth1 corresponding to an on-event indicating that the change amount of the photocurrent exceeds an upper limit threshold and a threshold voltage Vth2 corresponding to an off-event indicating that the change amount falls below a lower limit threshold at different timings, so that one comparator 3341 can detect a plurality of types of address events.

For example, the storage unit 336 may accumulate the comparison result of the comparator 3341 using the threshold voltage Vth1 corresponding to the on-event in a period in which the threshold voltage Vth2 corresponding to the off-event is supplied from the control unit 337 to the inverting (−) input terminal of the comparator 3341. Note that the storage unit 336 may be inside the EVS pixel 308b or outside the EVS pixel 308b. Furthermore, the storage unit 336 is not an essential component of the EVS AFE 314. That is, the storage unit 336 may be omitted.

As described above, according to the present embodiment, as described above, according to the present embodiment, the individual image sensor 200 including a plurality of EVS pixels 308b is arranged on the opposite side of the display surface of the display unit 170. With this configuration, according to the luminance signals of the plurality of EVS pixels 308b, an event signal can be output in a case where the change in the luminance of the light incident via the display unit 170 is larger than a predetermined threshold. Furthermore, by providing the individual image sensor 200 including the EVS pixel 308b below the display unit 170, occlusion can be curbed.

Furthermore, a wide-angle lens having a predetermined thickness such as a fisheye lens can be arranged in the optical system 110.

### Second Embodiment

An electronic device 100 according to a second embodiment is different from the electronic device 100 according to the first embodiment in further including a function capable of estimating the user's emotional state. Hereinafter, differences from the electronic device 100 according to the first embodiment will be described.

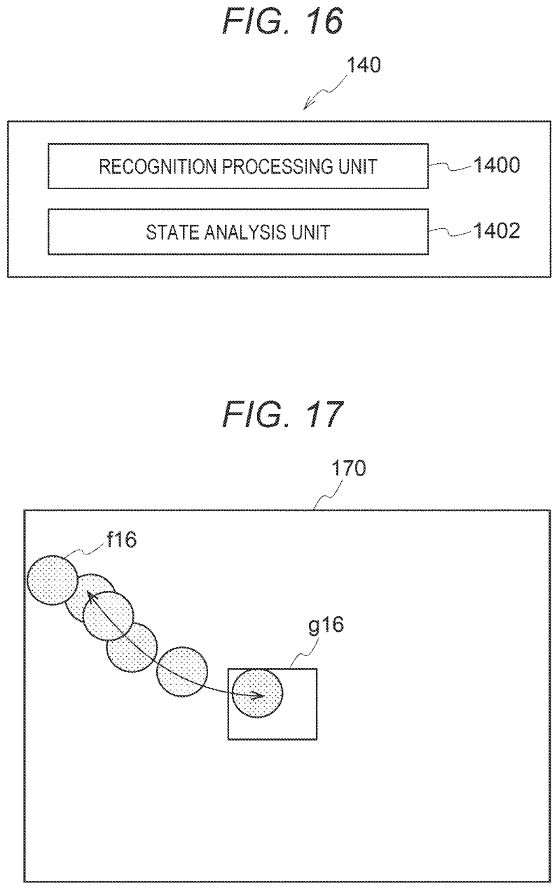

FIG. 16 is a block diagram illustrating a configuration example of an analysis unit 140. As illustrated in FIG. 16, the analysis unit 140 includes a recognition processing unit 1400 and a state analysis unit 1402. The analysis unit 140 includes, for example, a central processing unit (CPU). For example, a recording unit 120 (see FIG. 1) also stores various programs for executing processing in the analysis unit 140. With this configuration, the analysis unit 140 forms each unit, for example, by executing a program stored in the recording unit 120.

FIG. 17 is a schematic diagram illustrating the movement of a fingertip region f16 captured via a display unit 170. As illustrated in FIG. 17, mapping to a first EVS image is started from an end of the display unit 170, and the fingertip region f16 moves to a target position g16 touched by the fingertip region f16.

The recognition processing unit 1400 recognizes the observation target on the basis of, for example, the first EVS image. The recognition target according to the present embodiment is, for example, the fingertip. A general processing algorithm can be used for the recognition processing. For example, an occurrence region of an address event in the first EVS image is labeled, and if the area in the region labeled in a U shaped or a ring shape is within a predetermined range, it is recognized as a fingertip. In the first EVS image, a region corresponding to the edge part of the observation target is an occurrence region of an address event. Therefore, the case of the fingertip, for example, the occurrence region of an address event is labeled in a U shape or a ring shape. Then, the recognition processing unit 1400 sequentially outputs recognition signals including information indicating that the observation target is the finger and information indicating the barycentric coordinates of the fingertip region f16 to the state analysis unit 1402.

The state analysis unit 1402 estimates a user feeling on the basis of a behavior (such as hesitation) of the user in a touch panel operation on the display unit 160.

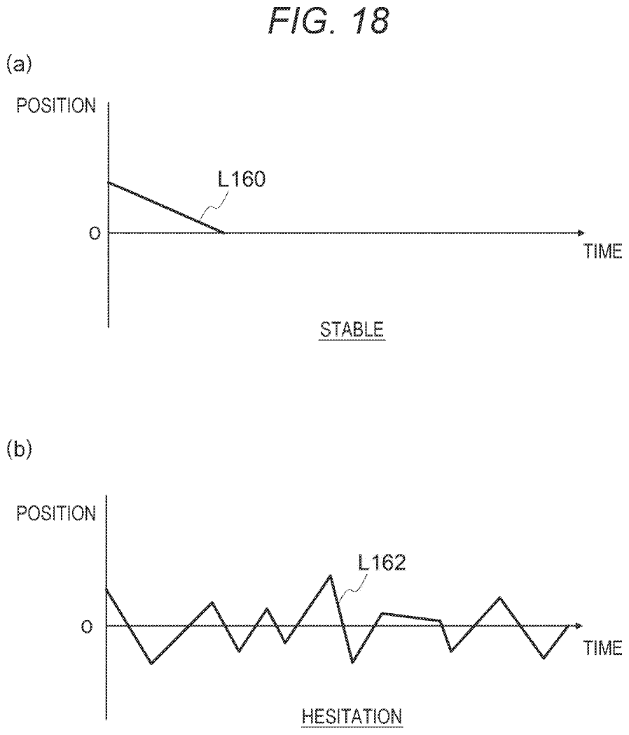

FIG. 18 is a diagram illustrating an example of data used for analysis by le state analysis unit 1402. The horizontal axis represents time, and the vertical axis represents, for example, a vertical distance from the target position g16. Here, the target position g16 is indicated as 0.

Here, (a) of FIG. 18 is a diagram illustrating a state in which the user has no hesitation about the target position g16, that is, is mentally stable. On the other hand, (b) is a diagram illustrating a state in which the user has hesitation about the target position g16, that is, is mentally unstable.

As illustrated in (a) of FIG. 18, when the user has no hesitation, the target position g16 is reached in a shorter time. On the other hand, as illustrated in (b) of FIG. 18, in a case where the user has hesitation, even when the finger reaches the target position g16, the position of the fingertip oscillates, and it tends to take more time to touch the target position g16.

Therefore, the state analysis unit 1402 generates an evaluation value based on the time until the target position g16 is touched and the oscillation state, and evaluates the mental state on the basis of the evaluation value. For example, the evaluation value generated by the state analysis unit 1402 becomes larger as the time until the target position g16 is touched becomes longer, and becomes larger as the oscillation number increases. With this configuration, the state analysis unit 1402 estimates that the mental state is stable when the evaluation value is a first threshold or less, unstable when the evaluation value is a second threshold or more, and normal when the evaluation value is greater than the first threshold and less than the second threshold. In this manner, by estimating the emotional state until the target position g16 is touched, it is possible to give feedback to improve operability. For example, in a case where hesitation is estimated, it is possible to improve the display mode such as the size and display color of the target position g16.

Furthermore, in a case where the target position g16 is a content selection button related to e-commerce, it is possible to give feedback regarding the user's psychological state and reflect the user's psychological state in a customer attraction method, an advertisement method, or the like. For example, in a case where hesitation is estimated, it is possible to improve the customer attraction method and advertisement method to reduce the hesitation.

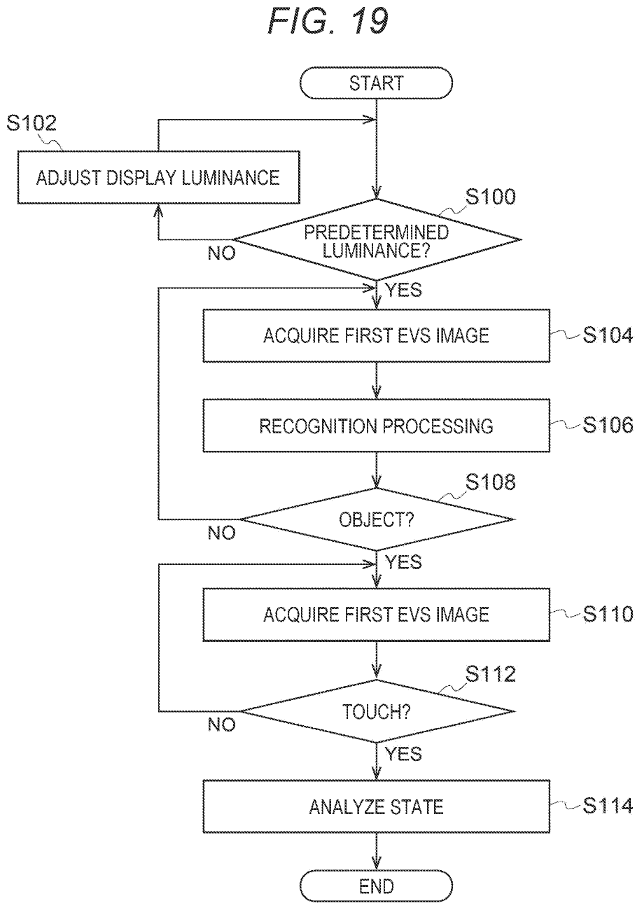

FIG. 19 is a flowchart illustrating a processing example of the second embodiment. As illustrated in FIG. 19, the control unit 130 first determines whether or not the luminance for the object is appropriate from the gradation image by the gradation pixels in the first mode (step S100). In this case, preliminary imaging is performed in the first mode in advance according to a display such as “Present finger” on the display unit 170. If the luminance adjustment is inappropriate (N in step S100), the light amount of the display unit 170 is adjusted (step S102).

On the other hand, if the luminance of the external environment is appropriate (Y in step S100), the control unit 130 proceeds to the third mode and repeats imaging of only the first EVS image (step S104). Subsequently, the recognition processing unit 1400 recognizes the observation target on the basis of, for example, the first EVS image (step S106).

Next, the state analysis unit 1402 determines whether or not the recognition processing unit 1400 has recognized the finger (step S108). If it is determined that the finger is recognized (Y in step S108), the state analysis unit 1402 captures only the first EVS image (step s106), and records the position coordinates and time of the fingertip until the user's finger touches the display unit 170 in the recording unit 120.

Next, the state analysis unit 1402 determines whether or not the user's finger has touched the display unit 170 on the basis of a signal from the touch panel 5 (see FIG. 3) (step S112). If it is determined that the finger has been touched, the state analysis unit 1402 performs state analysis (step S114) and ends the entire processing. On the other hand, if it is determined that the user's finger has not touched the display unit 170 (N in step S112), the processing from step S110 is repeated.

As described above, the state analysis unit 1402 records the behavior of the user regarding the touch panel operation of the display unit 170, and estimates a reason state using the oscillation of the user's finger with respect to the target position g160 and the time until the touch as evaluation values. As a result, the psychological state of the user can be objectively estimated. Furthermore, the relationship between the operation and the psychological state makes it possible to give feedback to improve operability. Moreover, in a case where the target position g16 is a content selection button related to e-commerce, it is possible to feed back the psychological state of the user at the time of selecting the content and reflect the psychological state in the customer attraction method, the advertisement method, or the like.

### Third Embodiment

An electronic device 100 according to a third embodiment is different from the electronic device 100 according to the second embodiment in that a function capable of estimating a touch position of the user by a first EVS image is further mounted. Hereinafter, differences from the electronic device 100 according the second embodiment will be described.

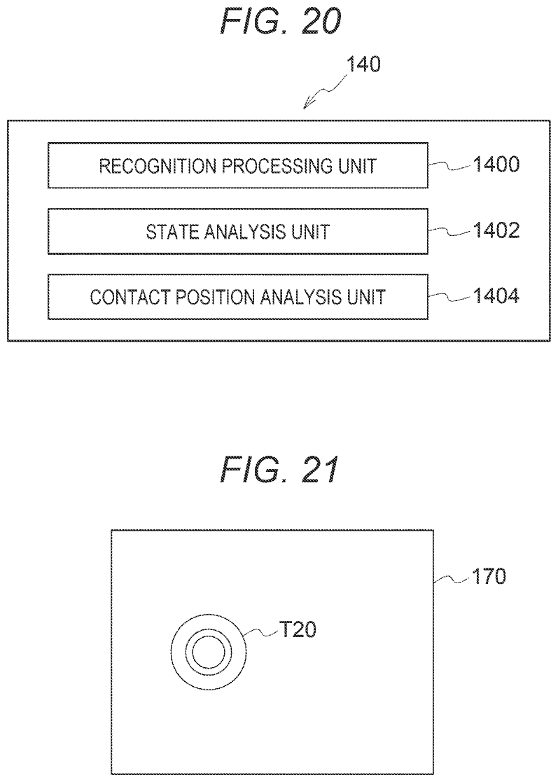

FIG. 20 is a block diagram illustrating a configuration example of an analysis unit 140 of the third embodiment. As illustrated in FIG. 20, the analysis unit 140 according to the third embodiment further includes a contact position analysis unit 1404.

FIG. 21 is a diagram schematically illustrating time-series images of a first EVS image in a superimposed manner at the same position, when a fingertip region f16 touches a cover glass 7 (see FIG. 4) of a display unit 170. As illustrated in FIG. 21, after the cover glass (see FIG. 4) is touched, a ripple T20 propagates as values of the address event. That is, in FIG. 21, the ring shape indicates that time elapses as the ring shape increases. As described above, when the cover glass 7 of the display unit 170 is touched, the ripple T20 that is a propagation pattern of a specific address event value is observed. In this case, different propagation patterns are observed in the case of touching with the ball of the finger and the case of touching with the tip of the nail.

The contact position analysis unit 1404 determines whether or not the finger has touched the cover glass 7 of the display unit 170 from the form of the spread of the address event values of the first EVS images captured in time series. Then, when determining that there has been a touch, the contact position analysis unit 1404 analyzes the coordinates of the touch center. For example, barycentric coordinates of an address event value spreading in a ripple ring shape is set as the touch center.

Furthermore, the contact position analysis unit 1404 performs two-dimensional Fourier analysis on the superimposed images of the time-series first EVS images. As a result, the amplitude component for each frequency is analyzed, and it is determined whether the touch is made with the ball of the finger or with the fingertip such as a nail. For example, in a case where the touch is made with the ball of the finger, the ratio between the value of the amplitude component near the low frequency and the value of the amplitude component near the high frequency is larger than that in a case where the touch is made with the fingertip such as a nail. In this manner, the contact position analysis unit 1404 determines whether the touch is made with the ball of the finger or with the fingertip such as the nail on the basis of the ratio between the value of the amplitude component near the low frequency and the value of the amplitude component near the high frequency. Then, a control unit 130 (see FIG. 1) changes display content to be displayed on the display unit 170 according to the contact position of the finger analyzed by the contact position analysis unit 1404. Furthermore, the control unit 130 (see FIG. 1) changes the display content to be displayed on the display unit 170 according to the contacted part analyzed by the contact position analysis unit 1404, such as the ball of the finger or the nail.

As described above, the contact position analysis unit 1404 analyzes the coordinates of the touch center from the form of the spread of the address event values of the first EVS images captured in time series. As a result, even when the electronic device 100 does not have a touch panel, the touch position on the cover glass 7 (see FIG. 4) by the user can be detected.

### Fourth Embodiment

An electronic device 100 according to a fourth embodiment is different from the electronic device 100 according to the third embodiment in further including a function capable of estimating an interaction between the user and a nearby person by a first EVS image. Hereinafter, differences from the electronic device 100 according to the second embodiment will be described.

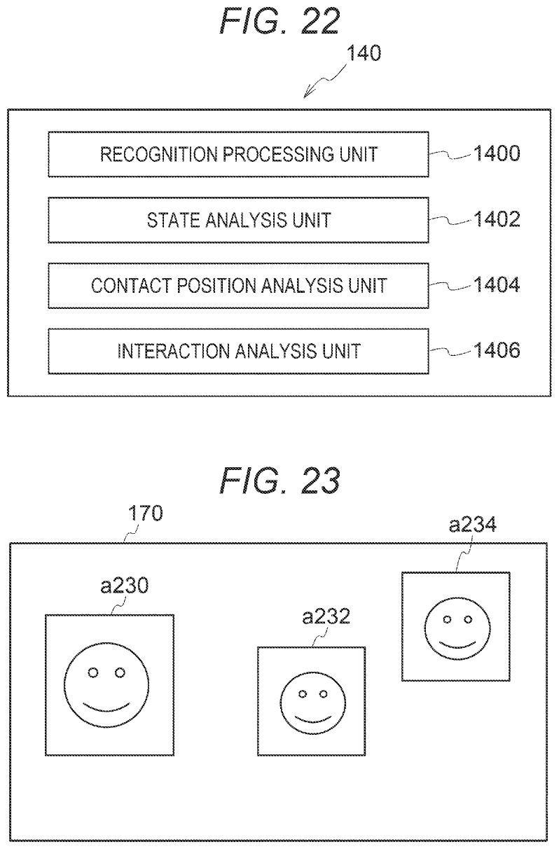

FIG. 22 is a block diagram illustrating a configuration example of an analysis unit 140 according to the fourth embodiment. As illustrated in FIG. 22, the analysis unit 140 according to the fourth embodiment further includes an interaction analysis unit 1406.

FIG. 23 is a diagram illustrating face regions a230, a232, and a234 recognized by a recognition processing unit 1400. FIG. 23 is a diagram schematically illustrating the face regions a230, a232, and a234 in the first EVS image.

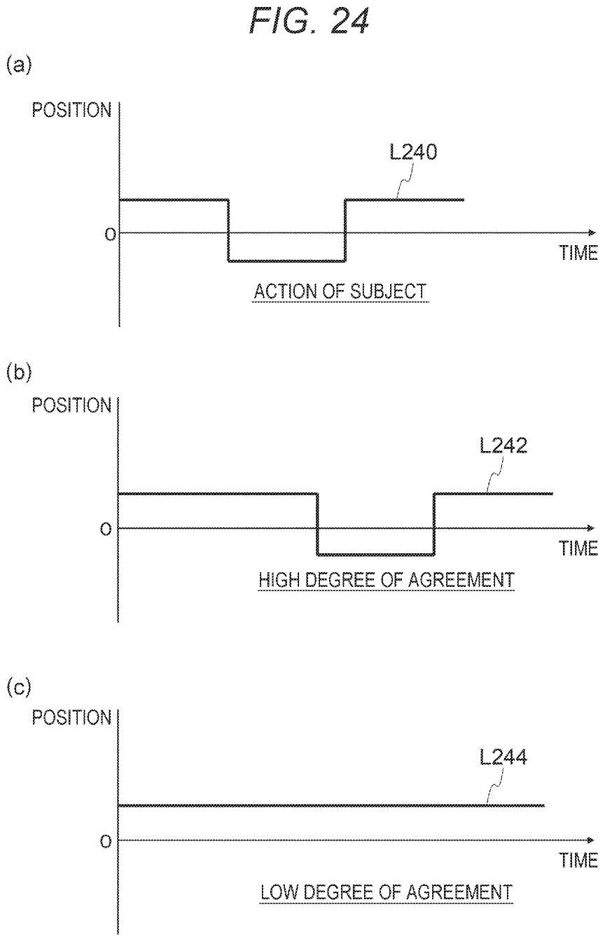

FIG. 24 is a schematic diagram illustrating a change in position of a lower jaw part of the face in time series. The horizontal axis indicates time, and the vertical axis indicates the position of the lower jaw part. FIG. 24(a) illustrates an operation example in the face region a230 of the subject by a line L240, and FIGS. 24(b) and 24(c) illustrate operation examples of the face areas a232 and a234 of nearby persons by lines L242 and L244. The values of the lines L240, L242, and L244 indicate the values of the vertical coordinates of the lower jaw in the first EVS image.

For example, a region below 0 of the line L240 in FIG. 24(a) illustrates a state in which the subject is nodding. A nodding action is also observed in the line L242 in the face region a232 of FIG. 24(b) so as to be synchronized with the nodding of the face region a230 of the subject. On the other hand, the value of the line L244 in the face region a234 of FIG. 24(b) is constant, that is, the position of the lower jaw is constant, and it is observed that the action is not synchronized with the nodding of the face region a230 of the subject.

The interaction analysis unit 1406 estimates the interaction between the subject and the nearby persons by the form of the temporal change of the position of the lower jaw of the first EVS images captured in time series. For example, when the movement of the jaw of the subject is observed and the movement of the jaw of the person around is observed in conjunction with the movement, it is estimated that the degree of agreement is high. On the other hand, in a case where the linkage of the movement of the jaw of the person around is not observed, it is estimated that the degree of agreement is low.

More specifically, the interaction analysis unit 1406 records position coordinates such as the vertical coordinates of the address event value corresponding to the position of the lower jaw for each of the face regions a230, a232, and a234 in the recording unit 120 (see FIG. 1) in time series as position information of the lower jaw. Then, the interaction analysis unit 1406 calculates a correlation value between the time-series variation value of the face region a230 of the subject and the time-series variation value for each of the face regions a232 and a234 of the compared person. The interaction analysis unit 1406 estimates that the higher the correlation value, the higher the degree of agreement. For example, the interaction analysis unit 1406 sets the threshold to 0.6, and estimates that the degree of agreement is high when the correlation value between L240 and each of L242 and L244 is 0.6 or more, and estimates that the degree of agreement is low when the correlation value is less than 0.6. Note that the threshold is an example, and is not limited to this. For example, the interaction analysis unit 1406 may set the thresholds to 0.65 and 0.55, and may estimate that the degree of agreement is high when the correlation is 0.65 or more, and may estimate that the degree of agreement is low when the correlation is less than 0.55.

As described above, the interaction analysis unit 1406 analyzes the temporal change of the position of the lower jaw in the first EVS images captured in time series. As a result, it is possible to estimate that the degree of agreement is high when the movement of the jaw of the person around is observed in conjunction with the position of the lower jaw of the subject, and it is possible to estimate that the degree of agreement is low when the movement of the jaw of the person around is not observed.

### Fifth Embodiment

An electronic device 100 according to a fifth embodiment is different from the electronic device 100 according to the fourth embodiment in further including a function of estimating a psychological state by analyzing the vibration of the user from a first EVS image. Hereinafter, differences from the electronic device 100 according to the fourth embodiment will be described.

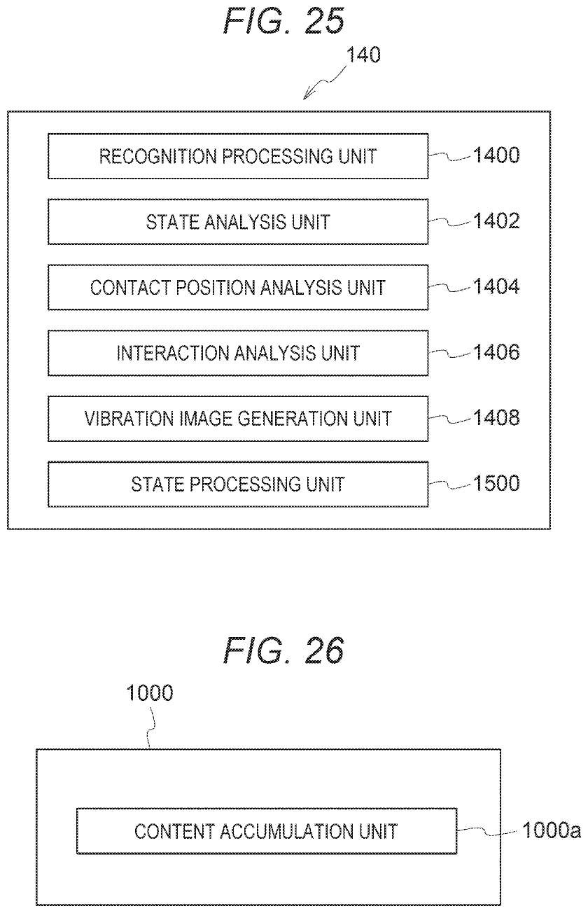

FIG. 25 is a block diagram illustrating a configuration example of an analysis unit 140 according to the fifth embodiment. As illustrated in FIG. 25, the analysis unit 140 according to the fifth embodiment further includes a vibration image generation unit 1408 and a state processing unit 1500.

FIG. 26 is a diagram schematically illustrating a server 1000 that supplies content to the electronic device 100. The server 1000 includes a content accumulation unit 1000a. Emotion information is associated with the content accumulated by the content accumulation unit 1000a in time series. For example, 1000 subjects are caused to view a content in advance, for example, and emotion information obtained by measuring psychological states in time series is acquired. For example, in a case where largest number of people show stability at a certain point of time, the emotion formation at that point of time is “stable”. On the other, hand, in a case where the largest number of people show instability at another certain point of time, the emotion information at that point of time is “unstable”.

Furthermore, in a case where the largest number of people show instability at a certain point of time, an improvement example for stabilizing emotions of the people is acquired as knowledge. This improvement example is also stored in association with the emotion information. As the improvement example, action examples include showing a relaxed content, promoting a relaxing action such as deep breathing, stretching, or the like.

FIG. 27 is a diagram illustrating an example of the first EVS images captured in time series. FIG. 27 lustrates the first EVS images captured in time series from time t0 to time t3. The first EVS image includes an address event value. For example, if there is an address event, the value is 1, and if there is no address event, the value is 0. Therefore, for example, when the cycle of the address event 1 of a certain pixel is analyzed information on the vibration state of the user in the pixel is acquired.

The vibration image generation unit 1408 generates a vibration image of the user on the basis of a cycle of the address event for each pixel acquired in time series.

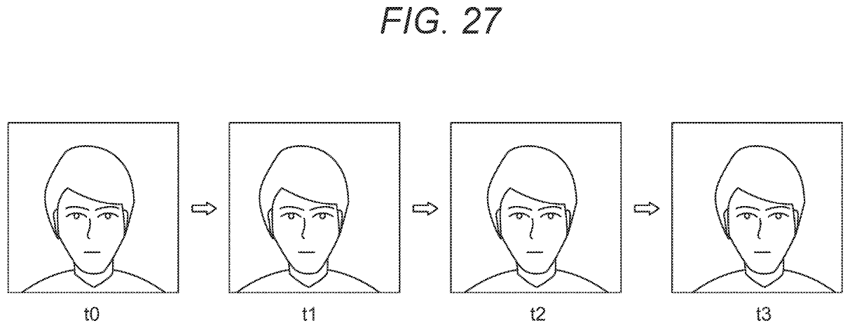

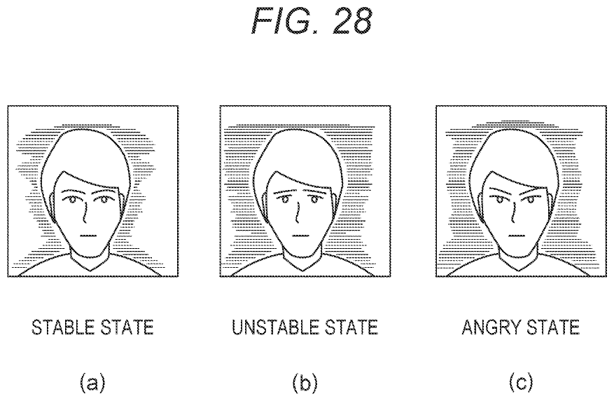

FIG. 28 is a diagram schematically illustrating the vibration image generated by the vibration image generation unit 1408. For example, FIG. 28(a) illustrates a stable state, FIG. 28(b) illustrates, for example, an unstable state, and FIG. 28(c) illustrates, for example, an angry state, such as a state in which aggressiveness is increased. It is known that the characteristics of movement and the speed of fine movement of various parts of the human body depend on the psychophysiological state, and only slightly depend on the kinetic activity itself and the macromotion. In active psychophysiological states with increased levels of aggressiveness, stress, and anxiety, characteristics of fine movements of the entire body (vibrations from mechanical point of view) are determined by psychophysiological processes, and movements of the shoulder, chest, and pelvis are known to have a high correlation with fine movements of the head.

A state analysis unit 1402 according to the fifth embodiment estimates a psychological state of the user, such as an emotion, on the basis of a vibration image generated by the vibration image generation unit 1408. For this estimation method, for example, a technology disclosed in Patent Document 2 can be used. The state analysis unit 1402 according to the fifth embodiment is different from the technology disclosed in Patent Document 2 in that a vibration image generated by the vibration image generation unit 1408 is used.

The state processing unit 1500 displays, on the display unit 170, an image in a display form according to the estimation result of the state analysis unit 1402.

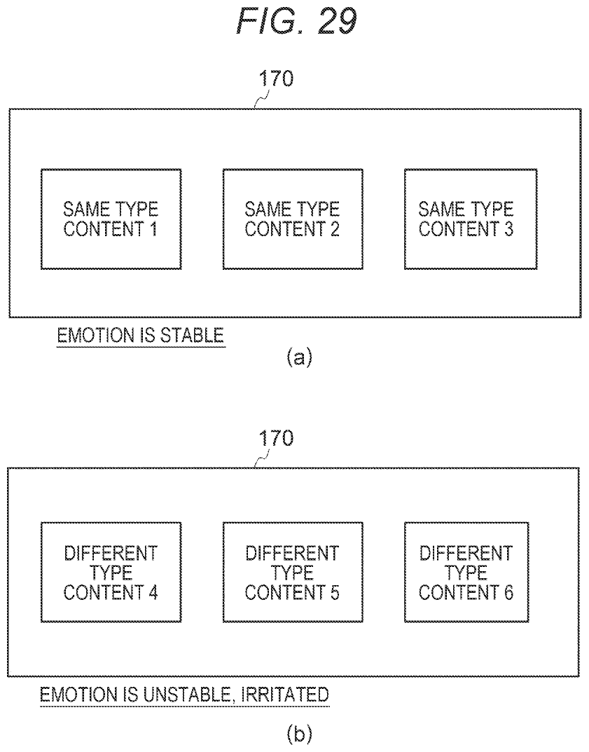

FIG. 29 is a diagram illustrating an example of an image displayed by the state processing unit 1500. Here, (a) of FIG. 29 illustrates an image displayed in a case where the emotion is stable in the estimation result of the state analysis unit 1402. Meanwhile, (b) of FIG. 29 is an image displayed in a case where the emotion is unstable in the estimation result of the state analysis unit 1402. As illustrated in (a) of FIG. 29, in a case where the overall emotion is stable, it is determined that the user is satisfied with the content being displayed, and contents of the same type are displayed on the display unit 170 as options.

On the other hand, as illustrated in (b) of FIG. 29, in a case where the overall emotion is unstable, it is determined that the user is not satisfied with the content being displayed, and contents of types different from the content being displayed are displayed on the display unit 170 as options. In this way, by changing the selectable content according to the user's emotion, it is possible to display contents closer to the user's intention as options.

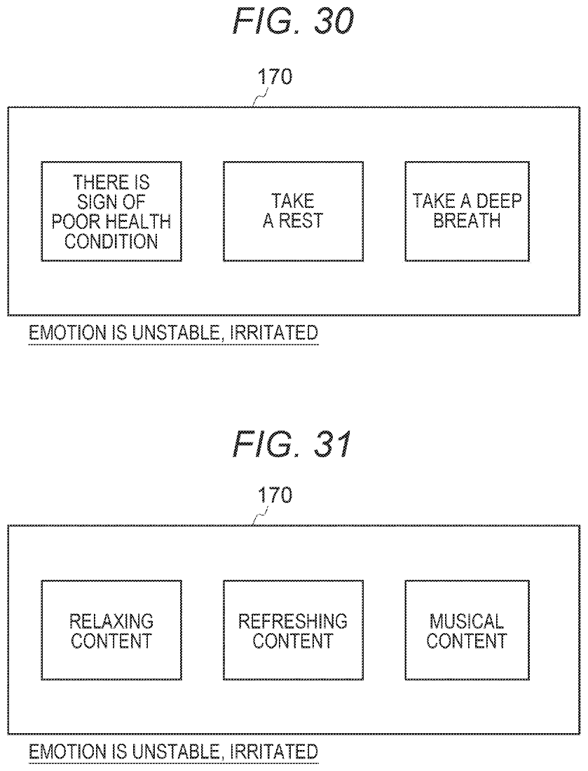

FIG. 30 is a diagram illustrating another image example displayed by the state processing unit 1500. FIG. 30 is an image displayed in a case where the emotion is unstable in the estimation result of the state analysis unit 1402. For example, the state processing unit 1500 causes the display unit 170 to display an image of promoting an action for encouraging relaxation, such as “there is sign of poor health condition”, “take a rest”, or “take a deep breath”. In this manner, an action proposal to the user can be made according to the result of sensing the user's emotion. As a result, the user notices his/her psychological state and performs an action according to the display, so that an increase in stress and the like can be curbed. Furthermore, the state processing unit 1500 can also make an action proposal to the user illustrated in FIG. 30 on the basis of information of improvement examples of the third party associated with contents being displayed from the content accumulation unit 1000a of the server 1000.

FIG. 31 is a diagram illustrating an example of an image using external information displayed by the state processing unit 1500. FIG. 31 illustrates an image displayed in a case where the emotion is unstable in the estimation result of the state analysis unit 1402. The state processing unit 1500 acquires information of an improvement example associated with the content being displayed from the content accumulation unit 1000a of the server 1000. For example, a relaxing content is a content that has a proven record to stabilize emotions of many people. For example, it is known that when this content is displayed, the pulse of many people is stabilized, and the blood pressure also decreases. Similarly, a refreshing content is a content that has a proven record to raise emotions of many people. For example, it is known that when this content is displayed, many people are motivated. Similarly, a musical content a content that has a proven record to stabilize emotions of many people. For example, it is known that when this content is displayed, the pulse of many people is stabilized, and the blood pressure also decreases. In this manner, the state processing unit 1500 can display more suitable healthcare contents according to the estimation result of the state analysis unit 1402.

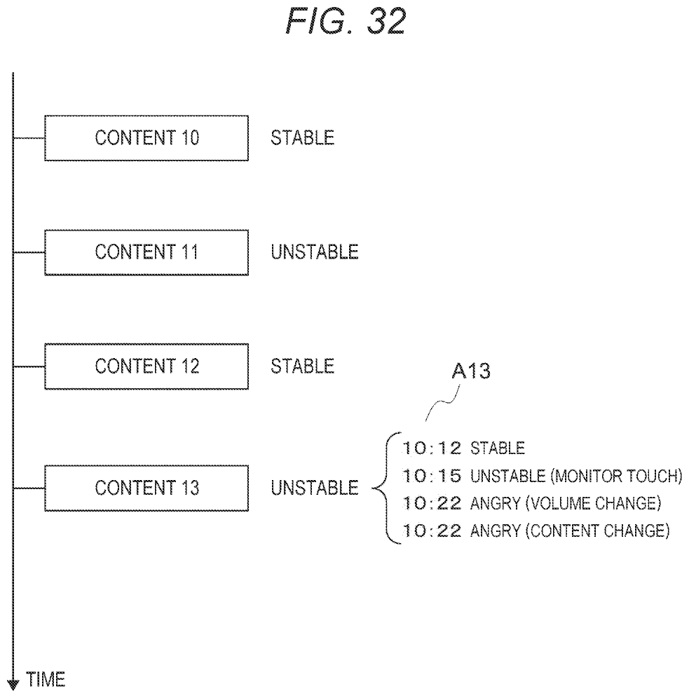

FIG. 32 is a diagram schematically illustrating a recording state of an estimation result in the state analysis unit 1402. The vertical axis represents time. The state analysis unit 1402 records the psychological state when displaying the content in the recording unit 120 (see FIG. 1), and transmits the psychological state to the server 1000 via the communication unit 150 (see FIG. 1). The server 1000 increases accumulation of information as an example of a psychological state of the user for the content. The chronological feeling and the behavior at that time may be recorded so as to be displayed in a region A31 of the content 13. With this configuration, it is also possible to analyze the relationship among details of the content, the user's emotion, and the user's behavior.

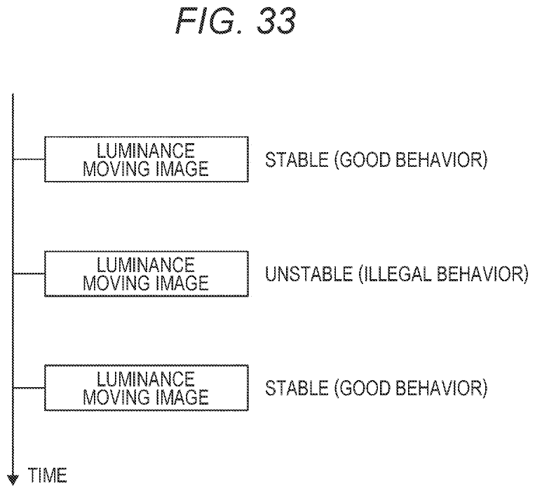

FIG. 33 is a diagram schematically illustrating a recording state of an estimation result in the state analysis unit 1402 in a case where imaging is performed in the second mode. The vertical axis represents time. As described above, in the second mode, a luminance moving image that is a moving image of the second EVS image is also captured.

As illustrated in FIG. 33, by recording the behavior and emotions of the user by the state analysis unit 1402, it is possible to detect involvement in a specific behavior, such as a good behavior, an illegal behavior, or the like. For example, when the luminance image in the unstable state is analyzed, an illegal behavior or the like can be more efficiently detected. On the other hand, when the luminance image in the stable state is analyzed, a good behavior or the like can be more efficiently detected.

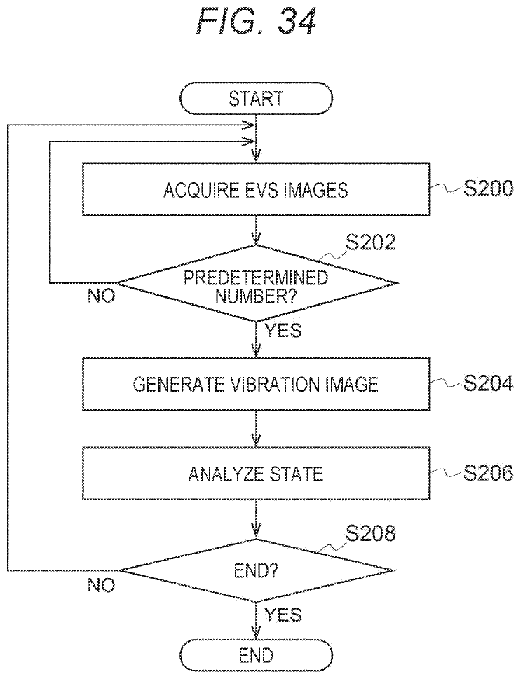

FIG. 34 is a flowchart illustrating a flow of user state analysis using the vibration image of the user. First, the vibration image generation unit 1408 acquires the first EVS images recorded in the recording unit 120 in time series (step S200). Subsequently, the vibration image generation unit 1408 determines whether or not a predetermined number of first EVS images necessary for generating a vibration image have been acquired (step S202). If the images are not acquired (N in step S202), the processing from step S200 is repeated.

On the other hand, if the images are acquired (Y in step S202), the vibration image generation unit 1408 generates a vibration image (step S204).

Next, the state analysis unit 1402 estimates the psychological state of the user using the vibration image generated by the vibration image generation unit 1408. Subsequently, the state analysis unit 1402 determines whether or not to end the processing (step S208), and if the processing is not to be ended (N in step S208), repeats the processing from step S200. On the other hand, if the processing is to be ended (Y in step S208), the entire processing is ended.

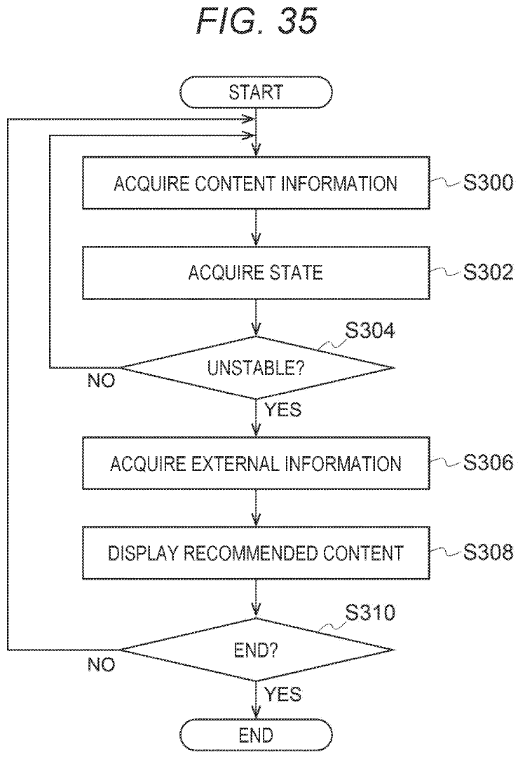

FIG. 35 is a flowchart illustrating a flow of user state analysis at the time of content display. First, the state processing unit 1500 acquires content information selected by the user (step S300). Subsequently, the state processing unit 1500 acquires information regarding the psychological state of the user sequentially estimated by the state analysis unit 1402 (step S302).

Next, the state processing unit 1500 determines whether or not the psychological state of the user acquired from the state analysis unit 1402 is unstable (step S304). If the state is not unstable (N in step S304), the processing from step S300 is repeated.

On the other hand, if the state is unstable (Y in step S304), information on an improvement example associated with the content being displayed is acquired from the content accumulation unit 1000a of the server 1000 via the communication unit 150 (see FIG. 1) (step S306). Then, the state processing unit 1500 causes the display unit 170 to display tie content having a proven record of improvement as a recommended content as an option for the user on the basis of the information of the improvement example associated with the content being displayed (step S308).

Next, the state processing unit 1500 determines whether or not to end the entire processing (step S310) If it is determined not, to end the processing (N in step S310), the processing from step S300 is repeated. On the other hand, if it is determined to end the processing (Y in step S310), the overall processing is ended.

As described above, the state analysis unit 1402 according to the present embodiment estimates the psychological state of the user using the vibration image of the user generated by the vibration image generation unit 1408. As a result, the psychological state of the user can be objectively estimated. Furthermore, since the psychological state of the user who is displaying the content can be estimated, options for the next content can be changed according to the psychological state of the user.

Furthermore, in a case where a psychological state of the user who is displaying the content is unstable, contents corresponding to an improvement measure associated with the content is displayed on the display unit 170 as options. As a result, it is possible to allow the user to select content having a proven record of improvement.

### Sixth Embodiment

An electronic device 100 according to a sixth embodiment is different from the electronic device 100 according to the fifth embodiment in further including a function of changing an arrival region of a sound emitted by a speaker unit 160 by analyzing the arrival region of the sound emitted by the speaker unit 160. Hereinafter, differences from the electronic device 100 according to the fifth embodiment will be described.

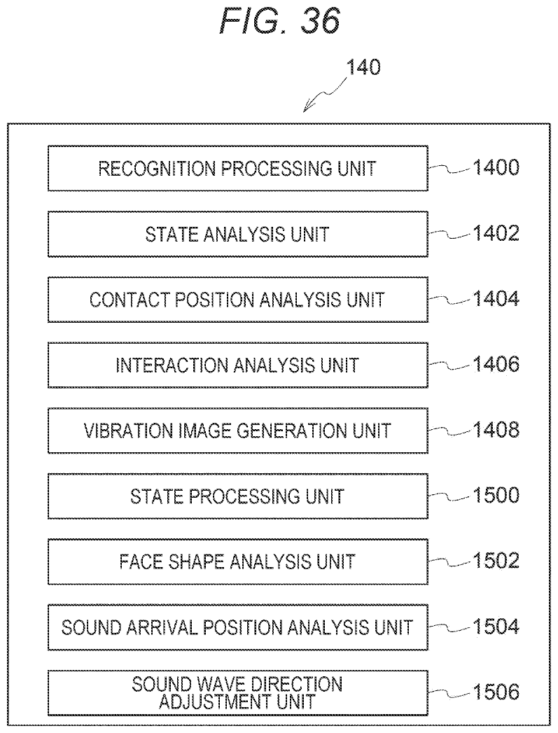

FIG. 36 is a block diagram illustrating a configuration example of an analysis unit 140 according to the sixth embodiment. As illustrated in FIG. 36, the analysis unit 140 according to the sixth embodiment further includes a face shape analysis unit 1502, a sound arrival position analysis unit 1504, and a sound wave direction adjustment unit 1506.

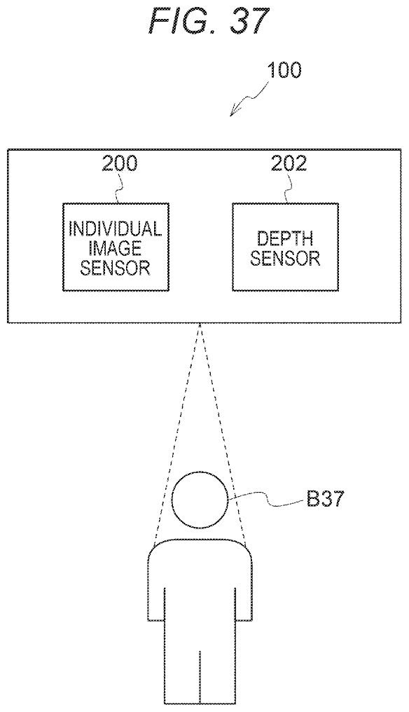

FIG. 37 is a diagram schematically illustrating a sensor configuration of the electronic device 100 according to the sixth embodiment. As illustrated in FIG. 37, the electronic device 100 according to the sixth embodiment includes an individual image sensor 200 and a depth sensor 2000. The depth sensor 2000 is a sensor capable of generating three-dimensional shape data of a user B37. Captured images of the individual image sensor 200 and the depth sensor 2000 can be associated with coordinates of pixels thereof and can be processed by fusion.

FIG. 38 is a diagram schematically illustrating a vertical cross section of the speaker unit 160 of the electronic device 100 according to the sixth embodiment. As illustrated in FIG. 38, the electronic device 100 according to the sixth embodiment includes a first speaker 160a having high directivity and a second speaker 160b having similarly high directivity. A baseline BL corresponds to a horizontal plane of the display unit 170. The first speaker 160a and the second speaker 160b are configured such that the orientations with respect to the baseline BL can be changed according to angles θ1, θ2. The first speaker 160a emits sound waves Sa having high directivity in a direction corresponding to angle θ1. Similarly, the second speaker 160b emits sound waves Sb having high directivity in a direction corresponding to angle θ2. Since these sound waves Sa and Sb have high directivity, viewing by a person other than the user B37 to which the sound waves Sa and Sb have reached is curbed. As described above, the speaker unit 160 is configured such that only the user B37 can hear the sound waves Sa and Sb.

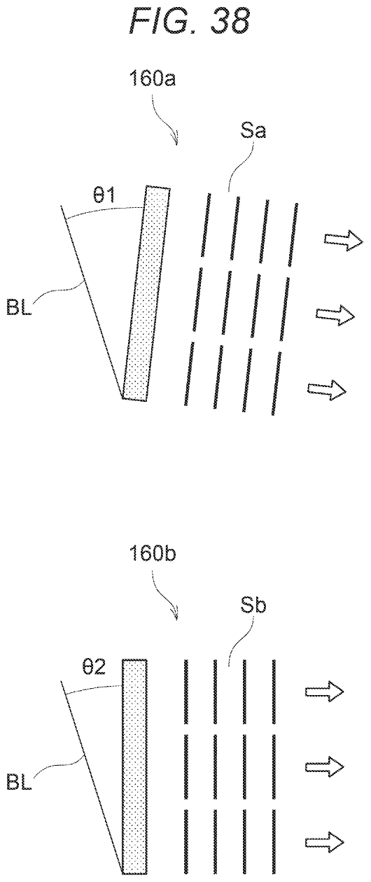

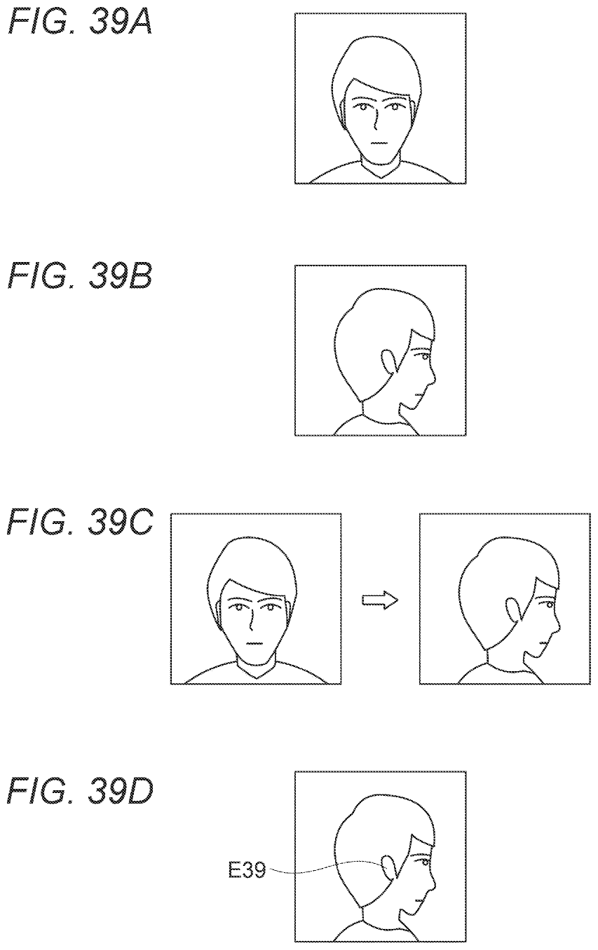

A processing example of the face shape analysis unit 1502 will be described with reference to FIGS. 39A to 39D. FIG. 39A is a diagram illustrating a three-dimensional image of the front of the user B37 captured by the depth sensor 2000. FIG. 39B is a diagram illustrating a three-dimensional image in an oblique direction of the user B37 captured by depth sensor 2000.

FIG. 39C is an image obtained by rotating the three-dimensional image of the front of the user B37 so as to match the three-dimensional image in the oblique direction of the user B37. FIG. 39D is a diagram in which position information of an ear E39 is acquired using the rotation angle and three-dimensional position information of both eyes, both ears, nose, and mouth.

As illustrated in FIG. 39A, the face shape analysis unit 1502 records, in the recording unit 120 (see FIG. 1) in advance, a three-dimensional image in which a skeleton is estimated on the basis of a three-dimensional image of the front of the user B37. Furthermore, a gradation image when the front of the user B37 illustrated in 30A is captured is also acquired and recorded in advance in the recording unit 120 (see FIG. 1). The face shape generating unit 1502 records the three-dimensional position information of both eyes, both ears, nose, and mouth in the three-dimensional image by the skeleton estimation of the front of the user B37 in the recording unit 120 using the recognition processing result of both eyes, both ears, nose, and mouth by the recognition processing unit 1400.

As illustrated in FIGS. 39B and 39C, in a case where the depth sensor 2000 captures the three-dimensional image in the oblique direction of the user B37, the face shape analysis unit 1502 rotates the three-dimensional image of the front of the user B37, and calculates the rotational position matching the three-dimensional image in the oblique direction of the user B37.

As illustrated in FIG. 39D, the face shape analysis unit 1502 estimates the position of the ear E39 in the three-dimensional image in the oblique direction of the user B37 using the three-dimensional position information of both eyes, both ears, nose, and mouth of the user B37 recorded in advance and the rotation angle. Furthermore, since the coordinates of the gradation image, the first EVS image, and the three-dimensional image are associated in advance, be face shape analysis unit 1502 can estimate the region of the ear E39 on tie first EVS image from the region information of the ear E39 acquired by the face shape analysis unit 1502. In this case, even if the ear E39 of the user B37 is hidden by hair or the like, the position of the ear E39 that is the target part can be estimated from the positional relationship of other parts (eyes, mouth, and the like).

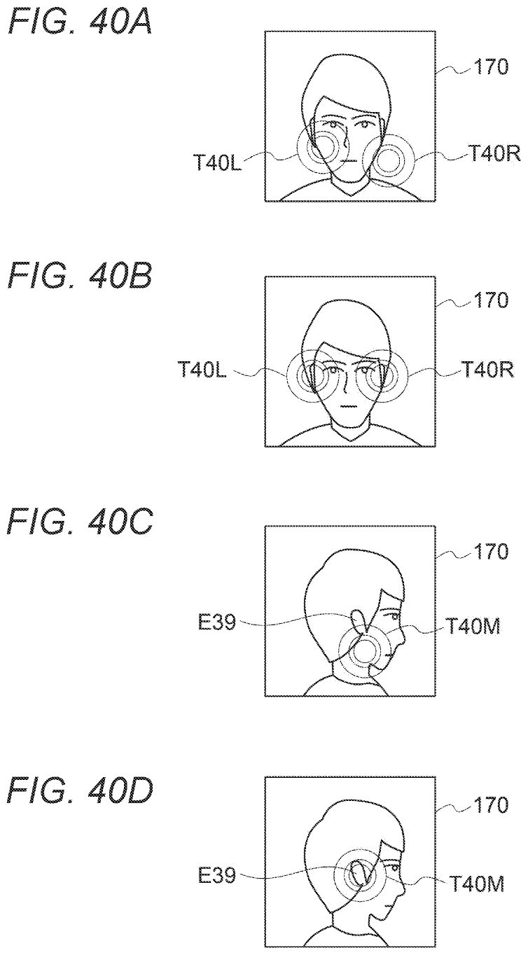

Processing examples of the sound arrival position analysis unit 1504 and the sound wave direction adjustment unit 1506 will be described with reference to FIGS. 40A to 40D. FIG. 40A is a diagram illustrating the first EVS images of the front of the user B37 captured in time series. T40L and T40R are regions exposed to sound waves, and the regions exposed to sound spreads in a wave shape with time. FIG. 40B is a diagram illustrating the first EVS images of the front of the user B37 captured in time series after sound wave direction adjustment. FIG. 40C is a diagram illustrating le first EVS images of the user B37 in an oblique direction captured in time series. T40 is a region exposed to sound waves, and the region exposed to sound spreads in a wave shape with time. FIG. 40D is a diagram illustrating the first EVS images of the user B37 in the oblique direction captured in time series after the sound wave direction adjustment.

As illustrated in FIG. 40A, the sound arrival position analysis unit 1504 estimates regions spreading in a ring shape as the regions T40L and T40R exposed to sound waves. Similarly, even in a case where only one ear is imaged, the region exposed to sound waves is estimated as the region 1404. Furthermore, the sound arrival position analysis unit 1504 can also analyze the time-series first EVS images to determine whether or not the user 337 is exposed to sound waves.

As illustrated in FIGS. 40B and 40D, the sound wave direction adjustment unit 1506 adjusts angles θ1 and θ2 with respect to the first speaker 160a and the second speaker 160b such that the position of the ear E39 estimated by, the face shape anal is unit 1502 matches the regions T40L, T40R, and T40M exposed to sound waves estimated by the sound arrival position anal sis unit 1504. In this manner, the region of the ear E39 of the user 337 can be constantly exposed to sound waves.

Furthermore, the sound arrival position analysis unit 1504 can also perform frequency analysis of a region exposed to sound by two-dimensional Fourier transform. In this case, the region corresponding to the frequency of the sound emitted from the speaker unit 160 alone can be estimated as the region of the ear E39. Therefore, in a case where there are a large number of sound sources, the estimation accuracy can be further improved.

Furthermore, the sound wave direction adjustment unit 1506 can combine the wavefronts of the sound waves Sa and Sb of the first speaker 160a and the second speaker 160b to generate a sound field specialized for the user B37. More specifically, the sound wave direction adjustment unit 1506 adjusts the orientation of the first speaker 160a and the second speaker 160b and the overlap of the wavefronts of the waves Sa and Sb, and generates a sound field that reaches the region of the ear E39 more intensively. Furthermore, the sound wave direction adjustment unit 1506 can determine whether or not there is a person nearby by a sensor on the basis of the processing result of the recognition processing unit 1400, and can change the intensity and range of the sound to be transmitted when there is a person nearby.

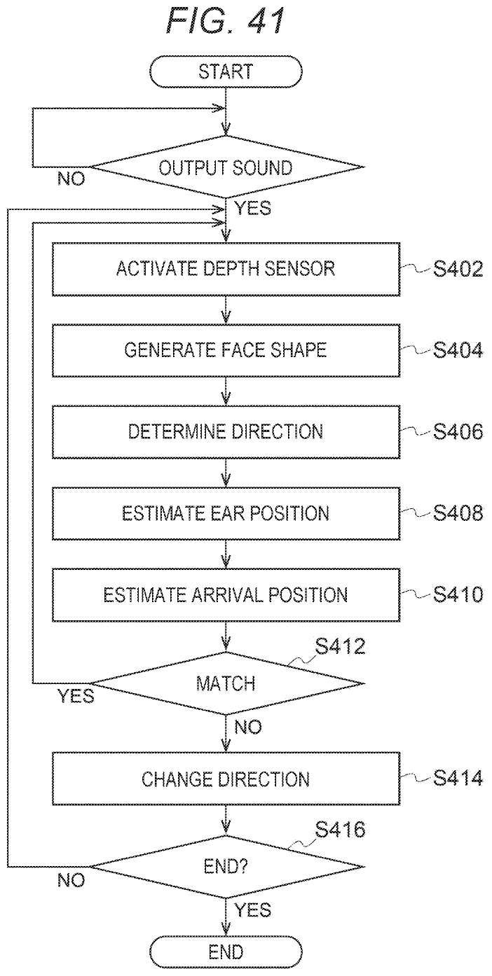

FIG. 41 is a flowchart illustrating a flow of a processing example of changing the direction of a sound. First, the sound arrival position analysis unit 1504 analyzes the time-series first EVS images and determines whether or not the user B37 is exposed to sound waves (step S400). If the user B37 is not exposed to sound waves (N in step S400), the processing in step S400 is repeated. On the other hand, if the user B37 is exposed to sound waves (Y in step S400), the control unit 130 activates the gradation pixel 308a and the depth sensor 2000 (see FIG. 37) in addition to the EVS pixel 308b (see FIG. 7) (step S402). As a result, the first EVS image, the depth image, and the gradation image are acquired.

Next, the face shape analysis unit 1502 generates a three-dimensional image of the user B37 on the basis of the depth image of the depth sensor 2000 (step S404). Subsequently, the face shape analysis unit 1502 rotates the front three-dimensional face image recorded in advance, and determines the direction of the face of the user B37 on the basis of the angle that matches the three-dimensional face image generated in step S404 (step S406).

Next, the face shape analysis unit 1502 estimates the position of the ear in the first EVS image using three-dimensional position information of both eyes, both ears, the nose, and the mouth recorded in advance and the rotation angle, that is, information of the direction of the face (step S408).

Next, the sound arrival position analysis unit 1504 estimates a region exposed to sound waves (step S410). Subsequently, the sound wave direction adjustment unit 1506 determines whether or not the position of the ear estimated by the face shape analysis unit 1502 matches the region exposed to sound waves estimated by the sound arrival position analysis unit 1504 (step S412). Then, if the regions match (Y in step S412), the sound wave direction adjustment unit 1506 repeats the processing from step S402.

On the other hand, if the regions do not match (N in step S412), the sound wave direction adjustment unit 1506 adjusts angles θ1 and θ2 with respect to the first speaker 160a and the second speaker 160b such that the position of the ear estimated by the face shape analysis unit 1502 matches the area exposed to sound waves estimated by the sound arrival position analysis unit 1504 (step S414). Next, the sound wave direction adjustment unit 1506 determines whether or not to end the entire processing (step S416), and if it is determined not to end the entire processing (step S416), repeats the processing from step S402.

As described above, the sound arrival position analysis unit 1504 according to the present embodiment estimates the region exposed to sound waves using the first EVS image, and the sound wave direction adjustment unit 1506 adjusts angles θ1 and θ2 with respect to the first speaker 160a and the second speaker 160b such that the position of the ear estimated by the face shape analysis unit 1502 matches the region exposed to sound waves estimated by the sound arrival position analysis unit 1504. As a result, even if the user B37 moves, the region of the ear E39 of the user B37 can be constantly exposed to sound waves.

Note that the present technology can also be configured in the following manner.

(1) An electronic device including
a display unit that has a display region in which display elements are arranged in an array in a first direction and a second direction different from the first direction, and
an image sensor that is disposed on a side opposite to a display surface of the display unit so as to overlap the display region in a third direction different from the first direction and the second direction, and includes a plurality of pixels, in which
the display unit transmits incident light, and
the plurality of pixels outputs an event signal in a case where a change in luminance of light incident via the display unit is larger than a predetermined threshold.

(2) The electronic device according to (1), further including a state analysis unit that analyzes a behavior of a user in a contact operation on the display unit using information of the event signal and estimates a user feeling.

(3) The electronic device according to (1) or (2), further including a contact position analysis unit that estimates a position at which the user has contacted the display unit by using information of the event signal.

(4) The electronic device according to (3), in which the contact position analysis unit uses propagation information of the event signal to distinguish an object that touched the display unit.

(5) The electronic device according to further including a control unit that controls the display unit, in which
a display content to be displayed on the display unit is changed according to at least one of the contact position or the touched object.

(6) The electronic device according to (1), in which
a display content to be displayed on the display unit is changed on the basis of a vibration image of a user generated using information of the event signal.

(7) The electronic device according to (6), further including a state analysis unit that estimates a user's emotion on the basis of the vibration image of a user generated using information of the event signal.

(8) The electronic device according to (7), further including a state processing unit that causes the display unit to display an image according to an estimation result of the state analysis unit.

(9) The electronic device according to (7), in which
the state processing unit causes the display unit to display an image for healthcare according to an estimation result of the state analysis unit.

(10) The electronic device according to (8), in which
the state processing unit causes the display unit to display a content option according to an estimation result of the state analysis unit.

(11) The electronic device according to (8), in which
the state processing unit causes the display unit to display an action proposal to the user according to an estimation result of the state analysis unit.

(12) The electronic device according to (11), in which
the action proposal is based on information of an improvement example of a third party acquired from an external server.

(13) The electronic device according to (1), further including a speaker unit that emits a sound, and
a sound arrival position analysis unit that estimates a part of the user exposed to the sound emitted from the speaker unit, using information of the event signal.

(14) The electronic device according to (13), in which
the sound arrival position analysis unit determines whether or not an ear of a user is exposed to a sound emitted from the speaker unit.

(15) The electronic device according to (14), further including a sound wave direction adjustment unit that controls an orientation of the speaker according to an arrival position of a sound analyzed by the sound arrival position analysis unit.

(16) The electronic device according to (15), in which
the sound wave direction adjustment unit controls an orientation of the speaker such that a sound directly reaches the ear of the user.

(17) The electronic device according to (16), further including a face shape analysis unit that records three-dimensional position information of both eyes, both ears, a nose, and a mouth in a three-dimensional image of the user in a recording unit.

(18) The electronic device according to (17), in which
the face shape analysis unit estimates a position of an ear in three images in an oblique direction of the user by using three-dimensional position information or both eyes, both ears, a nose, and a mouth of the user recorded in advance and a rotation angle of the three-dimensional image of the user.

(19) The electronic device according to (18), in which
the sound arrival position analysis unit can change an arrival position extracted by analysis according to an audio wavelength of the speaker.

(20) The electronic device according to (19), in which
in a case where the sound arrival position analysis unit determines that a sound reaches the user on the basis of the event signal, a depth sensor that captures a three-dimensional image of the user is activated.

(21) The electronic device according to (20), in which
the sound arrival position analysis unit fuses an image based on the event signal and an image based on the depth sensor, and acquires three-dimensional position information of both eyes, both ears, a nose, and a mouth of the user.

(22) The electronic device according to (21), in which
the face shape analysis unit generates a three- dimensional image of the user by skeleton estimation after activation of the depth sensor.

(23) The electronic device according to (1), in which the event signal is acquired constantly.

(24) The electronic device according to (1), in which
the display unit is caused to emit light so as to satisfy sensitivity of the plurality of pixels.

(25) A method of control a g an electronic device including
a display unit that has a display region in which display elements are arranged in an array in a first direction and a second direction different from the first direction, and
an image sensor that is disposed on a side opposite to a display surface of the display unit so as to overlap the display region in a third direction different from the first direction and the second direction, and includes a plurality of pixels, in which
the display unit transmits incident light, and
the plurality of pixels outputs an event signal in a case where a change in luminance of light incident via the display unit is larger than a predetermined threshold.

Aspects of the present disclosure are not limited to the above-described individual embodiments, but include various modifications conceivable by those skilled in the art, and the effects of the present disclosure are not limited to the above-described contents. That is, various additions, modifications, and partial deletions can be made lout departing from the conceptual idea and gist of the present disclosure derived from the contents defined in the claims and equivalents thereof.

### REFERENCE SIGNS LIST

100 Electronic device
130 Control unit
160 Speaker unit
170 Display unit
200 Solid-state image sensor
1000 Server
1402 State analysis unit
1404 Contact position analysis unit
1504 Sound arrival position analysis unit
1506 Sound wave direction adjustment unit
2000 Depth sensor

1. An electronic device comprising
a display unit that has a display region in which display elements are arranged in an array in a first direction and a second direction different from the first direction, and
an image sensor that is disposed on a side opposite to a display surface of the display unit so as to overlap the display region in a third direction different from the first direction and the second direction, and includes a plurality of pixels, wherein
the display unit transmits incident light, and
the plurality of pixels outputs an event signal in a case where a change in luminance of light incident via the display unit is larger than a predetermined threshold.

2. The electronic device according to claim 1, further comprising a state analysis unit that analyzes a behavior of a user in a contact operation on the display unit by using information of the event signal and estimates a user feeling.

3. The electronic device according to claim 1, further comprising a contact position analysis unit that estimates a position at which the user has contacted the display unit by using information of the event signal.

4. The electronic device according to claim 3, wherein
the contact position analysis unit uses propagation information of the event signal to distinguish an object that touched the display unit.

5. The electronic device according to claim 4, further comprising a control unit that controls the display unit, wherein
the control unit changes a display content to be displayed on the display unit according to at least one of the contact position or the touched object.

6. The electronic device according to claim 1, wherein a display content to be displayed on the display unit is changed on a basis of a vibration image of a user generated using information of the event signal.

7. The electronic device according to claim 6, further comprising a state analysis unit that estimates a user's emotion on a basis of the vibration image of a user generated using information of the event signal.

8. The electronic device according to claim 7, further comprising, a state processing unit that causes the display unit to display an image according to an estimation result of the state analysis unit.

9. The electronic device according to claim 8, wherein the state processing unit causes the display unit to display an image for healthcare according to an estimation result of the state analysis unit.

10. The electronic device according to claim 8, wherein
the state processing unit causes the display unit to display a content option according to an estimation result of the state analysis unit.

11. The electronic device according to claim 8, wherein
the state processing unit causes the display unit to display an action proposal to the user according to an estimation result of the state analysis unit.

12. The electronic device according to claim 11, wherein
the action proposal is based on information of an improvement example of a third par acquired from an external server.

13. The electronic device according to claim 1, further comprising a speaker unit that emits a sound, and
a sound arrival position analysis unit that estimates a part of the user exposed to the sound emitted from the speaker unit, using information of the event signal.

14. The electronic device according to claim 13, wherein
the sound arrival position analysis unit determines whether or not an ear of a user is exposed to a sound emitted from the speaker unit.

15. The electronic device according to claim 14, further comprising a sound wave direction adjustment unit that controls an orientation of the speaker according to an arrival position of a sound analyzed by the sound arrival position analysis unit.

16. The electronic device according to claim 15, wherein
the sound wave direction adjustment unit controls an orientation of the speaker such that a sound directly reaches the ear of the user.

17. The electronic device according to claim 16, further comprising a face shape analysis unit that records three-dimensional position information of both eyes, both ears, a nose, and a mouth in a three-dimensional image of the user in a recording unit.

18. The electronic device according to clam 17, wherein
the face shape analysis unit estimates a position of an ear in three images in an oblique direction of the user by using three-dimensional position information of both eyes, both ears, a nose, and a mouth of the user recorded in advance and a rotation angle or the three-dimensional image of the user.

19. The electronic device according to claim 18, wherein
the sound arrival position analysis unit can change an arrival position extracted by analysis according to an audio wavelength of the speaker.

20. The electronic device according to claim 19, wherein
in a case where the sound arrival position analysis unit determines that a sound reaches the user on a basis of the event signal, a depth sensor that captures a three-dimensional image of the user is activated.

21. The electronic device according to claim 20, wherein
the sound arrival position analysis unit fuses an image based on the event signal and an image based on the depth sensor, and acquires three-dimensional position information of both eyes, both ears, a nose, and a mouth of the user.

22. The electronic device according to claim 21, wherein
the face shape analysis unit generates a three-dimensional image of the user by skeleton estimation after activation of the depth sensor.

23. The electronic device according to claim 1, wherein
the event signal is acquired constantly.

24. The electronic device according to claim 1, wherein
the display unit is caused to emit light so as to satisfy sensitivity of the plurality of pixels.

25. A method of controlling an electronic device including
a display unit that has a display region in which display elements are arranged in an array in a first direction and a second direction different from the first direction, and
an image sensor that is disposed on a side opposite to a display surface of the display unit so as to overlap the display region is a third direction different from the first direction and the second direction, and includes a plurality of pixels, wherein
the display unit transmits incident light, and
the plurality of pixels outputs an event signal in a case where a change in luminance of light incident via the display unit is larger than a predetermined threshold.
